(19) United States
(12) Patent Application Publication
(10) Pub. No.: US 2021/0011208 A1
(43) Pub. Date: Jan. 14, 2021

(54) OPTICAL ELEMENT

(71) Applicant: FUJIFILM Corporation, Tokyo (JP)

(72) Inventors: Yukito SAITOH, Minami-ashigara-shi (JP); Hiroshi SATO, Minami-ashigara-shi (JP); Daisuke KASHIWAGI, Minami-ashigara-shi (JP)

(73) Assignee: FUJIFILM Corporation, Tokyo (JP)

(21) Appl. No.: 17/034,549

(22) Filed: Sep. 28, 2020

Related U.S. Application Data
(63) Continuation of application No. PCT/JP2019/013764, filed on Mar. 28, 2019.

(30) Foreign Application Priority Data
Mar. 29, 2018 (JP) 2018-064561

(51) Int. Cl. G02B 5/24; G02B 5/30; G02B 5/20

(52) U.S. Cl. CPC G02B 5/24; G02B 5/208; G02B 5/203; G02B 5/3016

(57) ABSTRACT

Provided is an optical element in which the amount of light having a wavelength causing a disturbance noise can be reduced and light can be diffracted with a high diffraction efficiency. The optical element comprising: an optically-anisotropic layer that is formed using a composition including a liquid crystal compound and a dichroic colorant, in which the optically-anisotropic layer has a liquid crystal alignment pattern in which a direction of an optical axis derived from the liquid crystal compound changes while continuously rotating in at least one in-plane direction.

### CROSS-REFERENCE TO RELATED APPLICATIONS

This application is a Continuation of PCT International Application No. PCT/JP2019/013764 filed on Mar. 28, 2019, which claims priority under 35 U.S.C. § 119(a) to Japanese Patent Application No. 2018-064561 filed on Mar. 29, 2018. The above application is hereby expressly incorporated by reference, in its entirety, into the present application.

### BACKGROUND OF THE INVENTION

### 1. Field of the Invention

The present invention relates to an optical element that diffracts incidence light.

### 2. Description of the Related Art

In many optical devices or systems, polarized light is used, and an optical element for controlling reflection, collection, divergence, or the like is required.

JP2016-519327A discloses a polarization conversion system that includes a geometric phase difference hologram having an anisotropic alignment pattern.

JP2017-522601A discloses a diffractive optical element that is formed by patterning a thin film having optical anisotropy.

Kobayashi et al “Planar optics with patterned chiral liquid crystal” Nature Photonics, 2016. 66(2016) discloses that a wave surface of reflected light can be freely designed by changing a phase of light reflected from a cholesteric liquid crystal layer depending on a phase of a helical structure and by spatially controlling a phase of a helical structure, the cholesteric liquid crystal layer obtained by immobilizing a cholesteric liquid crystalline phase.

### SUMMARY OF THE INVENTION

The element that changes a liquid crystal alignment pattern in a plane to diffract light as described in JP2017-522601A can bend light in any direction, and thus application thereof to an optical member of a beam steering device can be expected.

However, single-wavelength laser light is mainly used as light used for beam steering. Therefore, light having a wavelength other than the wavelength of the light emitted from the laser becomes disturbance noise, which causes an error in the beam steering system. A method of reducing the influence of the disturbance noise with a simple configuration is desired.

An object of the present invention is to provide an optical element in which the amount of light having a wavelength causing a disturbance noise can be reduced and diffracted light having a high diffraction efficiency can be obtained.

In order to achieve the above-described object, the present invention have the following configurations.

[1] An optical element comprising:

an optically-anisotropic layer that is formed using a composition including a liquid crystal compound and a dichroic colorant,

in which the optically-anisotropic layer has a liquid crystal alignment pattern in which a direction of an optical axis derived from the liquid crystal compound changes while continuously rotating in at least one in-plane direction.

[2] The optical element according to [1],

wherein in the optically-anisotropic layer, directions of optical axes derived from the liquid crystal compound arranged in a thickness direction are the same.

[3] The optical element according to [1] or [2],

in which the optically-anisotropic layer is a cholesteric liquid crystal layer obtained by immobilizing a cholesteric liquid crystalline phase.

An optical element according to an aspect of the present invention is a diffractive optical element including an optically-anisotropic layer that is formed using a composition including a liquid crystal compound, in which the optically-anisotropic layer has a liquid crystal alignment pattern in which a direction of an optical axis derived from the liquid crystal compound changes while continuously rotating in at least one in-plane direction, and the optically-anisotropic layer includes a dichroic colorant.

With the optical element according to the aspect of the present invention having the above-described configuration, the amount of light having a wavelength causing a disturbance noise can be reduced, and diffracted light having a high diffraction efficiency can be obtained.

### BRIEF DESCRIPTION OF THE DRAWINGS

FIG. 1 is a schematic side view showing a liquid crystal alignment pattern in an optically-anisotropic layer of an optical element according to a first embodiment of the present invention.

FIG. 2 is a schematic plan view showing the liquid crystal alignment pattern in the optically-anisotropic layer of the optical element according to the first embodiment of the present invention.

FIG. 3 is a diagram showing a principle in which the optically-anisotropic layer functions as a diffraction grating.

FIG. 4 is a diagram schematically showing a diffraction phenomenon.

FIG. 5 is a schematic diagram showing reflected light and transmitted light in a case where randomly polarized incidence light is incident into the optical element according to the first embodiment of the present invention.

FIG. 6 is a schematic diagram showing the optical element in which an alignment film is provided on a support and the optically-anisotropic layer is provided on the alignment film.

FIG. 7 is a schematic plan view showing a design modification example of the optical element according to the first embodiment of the present invention.

FIG. 8 is a schematic side view showing an optical element according to a second embodiment of the present invention.

FIG. 9 is a schematic diagram showing reflected light and transmitted light in a case where randomly polarized incidence light is incident into the optical element according to the second embodiment of the present invention.

FIG. 10 is a diagram showing a schematic configuration of an exposure device that irradiates an alignment film with interference light.

FIG. 11 is a diagram showing a method of measuring a light intensity in a transmission optical element.

FIG. 12 is a diagram showing a method of measuring a light intensity in a reflective optical element.

### DESCRIPTION OF THE PREFERRED EMBODIMENTS

Hereinafter, an embodiment of an optical element according to the present invention will be described with reference to the drawings. In each of the drawings, for easy visual recognition, the reduced scale of components is different from the actual scale.

In the present specification, numerical ranges represented by “to” include numerical values before and after “to” as lower limit values and upper limit values. In addition, “perpendicular” or “parallel” regarding an angle represents a range of the exact angle ±10°.

In the present specification, visible light refers to light which can be observed by human eyes among electromagnetic waves and refers to light in a wavelength range of 380 to 780 nm. Invisible light refers to light in a wavelength range of shorter than 380 nm or longer than 780 nm. In addition, although not limited thereto, infrared light refers to invisible light in a wavelength range of longer than 780 nm and 2000 nm or shorter.

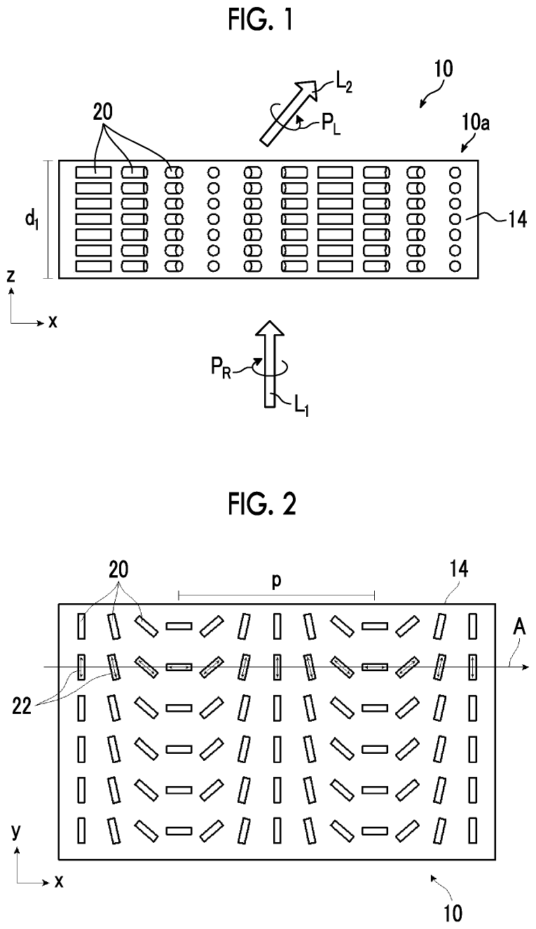

FIG. 1 is a schematic side view showing a liquid crystal alignment pattern in an optical element 10 according to a first embodiment of the present invention. FIG. 2 is a schematic plan view showing the liquid crystal alignment pattern in the optical element 10 shown in FIG. 1. In the drawing, a sheet plane of the sheet-shaped optical element 10 is formed in an x direction and a y direction perpendicular to each other. Accordingly, the sheet plane of the optical element 10 is a so-called x-y plane. In addition, a thickness direction perpendicular to the sheet plane, that is, a thickness direction is defined as a z direction.

The optical element 10 includes an optically-anisotropic layer 14 that is a cured layer of a liquid crystal composition including a liquid crystal compound.

The optically-anisotropic layer 14 has a liquid crystal alignment pattern in which an optical axis 22 derived from the liquid crystal compound 20 changes while continuously rotating in at least one in-plane direction of the optically-anisotropic layer 14.

The optical axis 22 derived from the liquid crystal compound 20 is an axis having the highest refractive index in the liquid crystal compound 22, that is, a so-called slow axis. For example, in a case where the liquid crystal compound 20 is a rod-shaped liquid crystal compound as in the example shown in the drawing, the optical axis 22 is along a rod-shaped major axis direction. In addition, in a case where the liquid crystal compound is a disk-shaped liquid crystal compound, the optical axis is positioned in a direction perpendicular to a disk plane.

In the optical element 10 according to the embodiment of the present invention, the optically-anisotropic layer 14 includes a dichroic colorant.

In the following description, a wavelength of light assumed as incidence light in the optical element according to the embodiment of the present invention will be referred to as “wavelength λ” for convenience of description. The wavelength λ may be a wavelength at which a peak intensity of incidence light is shown or may be a wavelength range of incidence light.

In the optical element 10 according to the first embodiment shown in FIG. 1, a retardation R (=Δn·d₁) of the optically-anisotropic layer 14 in the plane direction (in the drawing, the x-y direction) with respect to light having the wavelength λ is preferably 0.36λ to 0.64λ. The retardation R is preferably 0.42λ to 0.6λ, more preferably 0.45λ to 0.55λ, and still more preferably 0.5λk. Δn represents a birefringence of the optically-anisotropic layer 14 (liquid crystal compound 20), and d₁ represents a thickness of the optically-anisotropic layer 14.

For example, in a case where light having a wavelength of 940 nm is assumed as incidence light, that is, in a case where the wavelength λ is 940 nm, the retardation R with respect to the light having a wavelength of 940 nm may be in a range of 338 nm to 602 nm and is preferably 470 nm. By having the retardation R, the optically-anisotropic layer 14 exhibits a function as a λ/2 plate, that is, a function of imparting a phase difference of 180° (=π=λ/2) between linearly polarized light components of incidence light perpendicular to each other.

As shown in FIGS. 1 and 2, in the optically-anisotropic layer 14, the liquid crystal compound 20 is obtained by immobilizing a liquid crystal alignment pattern in which an optical axis changes while continuously rotating in the in-plane direction (direction along an axis A in FIG. 2). That is, the liquid crystal compound 20 is aligned such that an angle between the major axis (the axis of extraordinary light:director) of the liquid crystal compound 20 defined as the optical axis 22 of the liquid crystal compound 20 and the axis A gradually changes in the in-plane direction.

As shown in FIG. 1, in the optically-anisotropic layer 14, directions of optical axes 22 derived from the liquid crystal compound 20 arranged in the thickness direction are the same. The optically-anisotropic layer 14 functions as a transmission diffraction grating.

In the following description, the optical axis derived from the liquid crystal compound will also be simply referred to as “optical axis”.

The liquid crystal alignment pattern in which the direction of the optical axis 22 changes while rotating is a pattern in which the liquid crystal compound 20 is aligned and immobilized such that an angle between the optical axis 22 of the liquid crystal compound 20 arranged along the axis A and the axis A varies depending on positions in the axis A direction and gradually changes from ϕ to ϕ+180° or ϕ−180°.

The optically-anisotropic layer 14 shown in FIG. 2 has a liquid crystal alignment pattern in which the optical axis 22 of the liquid crystal compound 20 is parallel to the plane of the optically-anisotropic layer 14 and the direction of the optical axis 22 is constant in one plane direction (y direction) and changes while continuously rotating in a plane direction (x direction=axis A direction) perpendicular to the y direction. In other words, the optically-anisotropic layer 14 shown in FIG. 2 has the liquid crystal alignment pattern where long local regions (unit regions) that are elongated in the y direction in which the direction of the optical axis 22 is constant are arranged in the x direction perpendicular to the y direction and where the direction of the optical axis 22 continuously rotates in the x direction.

In the following description, the liquid crystal alignment pattern in which a component of the liquid crystal compound 20 parallel to the plane of the optical axis 22 changes while continuously rotating in at least one in-plane direction will also be referred to as “horizontal rotation alignment”.

“The optical axis 22 changing while continuously rotating” may represent that local regions having the same angle such as 30° rotate to be adjacent to each other in a range of 0° to 180° (=0°) as shown in FIGS. 1 and 2, or may represent that rotation angles of local regions adjacent to each other are different from each other. In the present invention, it is preferable that a change in the angle of the optical axis 22 in local regions adjacent to each other is uniform over the entire region in the x direction.

Even in a case where directions of the optical axes 22 of the liquid crystal compound 20 arranged in the y direction in the local region are slightly different from each other, as long as the average value of the directions of the optical axes 22 in the local region changes linearly at a constant ratio in the x direction, it can be said that the direction of the optical axis gradually changes.

However, a change in the slope of the optical axis in local regions adjacent to each other in the axis A direction and having different slopes of the optical axes 22 is preferably 45° or less. It is preferable that a change in slope in regions adjacent to each other is as small as possible.

In the optically-anisotropic layer 14 that is aligned by the horizontal rotation alignment, the optical axis 22 continuously rotates in the axis A direction. The distance over which an angle between the optical axis 22 and the axis A in the axis A direction changes from ϕ to ϕ+180° (returning to the original position) is set as a rotation period p. That is, the rotation period p refers to the distance over which the optical axis 22 rotates by 180° in the in-plane direction. The rotation period p of the optical axis 22 is preferably 0.5 μm to 5 μm.

Although described below in detail, as the rotation period p decreases, refraction of light increases, and as a wavelength of incidence light increases, refraction of light increases. Accordingly, The rotation period p may be determined depending on a wavelength of incidence light into the optical element and a desired emission angle.

With the above-described configuration of the optically-anisotropic layer 14, the optical element 10 imparts a phase difference of λ/2 and emits incidence light incident at an incidence angle of 0°, that is, light incident from the normal direction at an emission angle θ₂.

That is, as shown in FIG. 1, in a case where light L₁ of right circularly polarized light P_{R} (hereinafter, also referred to as “incidence light L₁”) is incident along the normal line of the optically-anisotropic layer 14, as conceptually shown in FIG. 4 described below, light L₂ of left circularly polarized light P_{L} (hereinafter, also referred to as “emitted light L₂”) is emitted in a direction having the angle θ₂ with respect to the normal direction. The normal line refers to a line perpendicular to a maximum surface (main surface) of a layer (a film, a sheet-shaped material, or a plate-shaped material). Accordingly, the normal direction refers to a direction perpendicular to the maximum surface of the layer.

As described above, in the optical element 10, in a case where light having a predetermined wavelength is incident, as the rotation period p of the optically-anisotropic layer 14 decreases, the emission angle of the emitted light L₂ increases.

In the optical element according to the embodiment of the present invention, the optically-anisotropic layer 14 includes a dichroic colorant in addition to the liquid crystal compound 20. Examples of this structure include a so-called guest host liquid crystal. In the present invention, the liquid crystal compound 20 is a host, and the dichroic colorant is a guest.

Although described below in detail, in the optical element according to the embodiment of the present invention, light absorbed by the dichroic colorant in the optically-anisotropic layer 14 has a wavelength different from the wavelength of the light assumed as incidence light in the optical element 10 according to the embodiment of the present invention, that is, the wavelength λ.

In a case where light is incident into the optically-anisotropic layer 14, light in an absorption wavelength range of the dichroic colorant is absorbed although affected by the action of diffraction described below. As a result, only diffracted light having the wavelength λ can be efficiently used, and the influence of light having a wavelength other than the wavelength λ, for example, the occurrence of an error can be reduced.

As in an optical element 10A shown in FIG. 6, the optical element 10 according to the embodiment of the present invention may include: an alignment film 13 that is provided on a support 12; and the optically-anisotropic layer 14 that is provided on the alignment film 13.

Hereinafter, the components of the optical element 10 will be described.

<Optically-Anisotropic Layer>

The optically-anisotropic layer according to the embodiment of the present invention is formed using a composition including the liquid crystal compound and the dichroic colorant. In order to form the optically-anisotropic layer, the composition including the liquid crystal compound may include other components such as a leveling agent, an alignment controller, a polymerization initiator, or an alignment assistant in addition to the liquid crystal compound. By forming an alignment film on the support, applying the composition to the alignment film, and curing the applied composition, the optically-anisotropic layer that is formed of the cured layer of the composition is obtained by immobilizing the predetermined liquid crystal alignment pattern can be obtained.

Next, each of the components of the liquid crystal composition according to the embodiment of the present invention will be described in detail.

[Optically-Anisotropic Layer]

The optically-anisotropic layer according to the embodiment of the present invention includes the dichroic colorant and the liquid crystal compound. The optically-anisotropic layer is formed using an optically-anisotropic layer-forming composition including the dichroic colorant and the liquid crystal compound.

<Dichroic Colorant>

The dichroic colorant is not particularly limited, and a well-known colorant of the related art can be used. A compound represented by Formula (2) below is preferably used.

In the present invention, the dichroic colorant refers to a colorant having different absorbances depending on directions.

The dichroic colorant may or may not be liquid crystalline.

In a case where the dichroic colorant is liquid crystalline, the liquid crystal properties may be nematic or smectic. A temperature range where a liquid crystal phase is exhibited is preferably room temperature (about 20° C. to 28° C.) to 300° C. and more preferably 50° C. to 200° C. from the viewpoints of handleability and manufacturing suitability.

The composition according to the embodiment of the present invention may include one dichroic colorant alone or may include two or more dichroic colorants.

In the present invention, two or more dichroic colorants may be used in combination. For example, from the viewpoint of increasing absorption of the optically-anisotropic layer with respect to visible light, it is preferable that at least one colorant compound (first dichroic colorant) having a maximum absorption wavelength in a wavelength range of 370 to 550 nm and at least one colorant compound (second dichroic colorant) having a maximum absorption wavelength in a wavelength range of 500 to 700 nm are used in combination. In addition, a transmittance of the dichroic colorant at 550 nm is preferably 30% or lower, and a transmittance of the dichroic colorant at 740 nm is preferably 60% or higher.

In the present invention, it is preferable that the dichroic colorant has a crosslinking group.

Specific examples of the crosslinking group include a (meth)acryloyl group, an epoxy group, an oxetanyl group, and a styryl group. In particular, a (meth)acryloyl group is preferable.

In the present invention, from the viewpoint of improving a balance between the alignment degree of the optically-anisotropic layer and the uniformity, the content of the dichroic colorant is preferably 5% to 25 mass %, more preferably 5% to 20 mass %, and still more preferably 10% to 15 mass % as a solid content ratio.

(Structure of Dichroic Colorant) It is preferable that the optically-anisotropic layer-forming composition includes a dichroic colorant represented by the following Formula (2) (hereinafter, abbreviated as “specific dichroic colorant”).

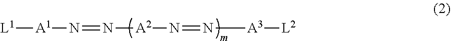

Here, in Formula (2), A¹, A², and A³ each independently represent a divalent aromatic group which may have a substituent.

In addition, in Formula (2), L¹ and L² each independently represent a substituent.

In Formula (2), m represents an integer of 1 to 4, and in a case where m represents an integer of 2 to 4, a plurality of A²'s may be the same as or different from each other. It is preferable that m represents 1 or 2.

In Formula (2), “divalent aromatic group which may have a substituent” represented by A¹, A², and A³ will be described.

Examples of the substituent include a substituent group G described in paragraphs “0237” to “0240” of JP2011-237513A. In particular, a halogen atom, an alkyl group, an alkoxy group, an alkoxycarbonyl group (for example, methoxycarbonyl or ethoxycarbonyl), or an aryloxycarbonyl group (for example, phenoxycarbonyl, 4-methylphenoxycarbonyl, or 4-methoxyphenylcarbonyl) is preferable, an alkyl group is more preferable, and an alkyl group having 1 to 5 carbon atoms is still more preferable.

On the other hand, examples of the divalent aromatic group include a divalent aromatic hydrocarbon group and a divalent aromatic heterocyclic group.

As the divalent aromatic hydrocarbon group, for example, an arylene group having 6 to 12 carbon atoms can be used, and specific examples thereof include a phenylene group, a cumenylene group, a mesitylene group, a tolylene group, and a xylylene group. In particular, a phenylene group is preferable.

In addition, as the divalent aromatic heterocyclic group, a monocycle or a group derived from a bicyclic heterocycle is preferable. Examples of an atom other than carbon forming the aromatic heterocyclic group include a nitrogen atom, a sulfur atom, and an oxygen atom. In a case where the aromatic heterocyclic group has a plurality of atoms forming the ring other than carbon, the atoms may be the same as or different from each other. Specific examples of the aromatic heterocyclic group include a pyridylene group (pyridine-diyl group), a quinolinene group (quinoline-diyl group), an isoquinolylene group (isoquinoline-diyl group), a benzothiadiazolediyl group, a phthalimide-diyl group, and a thienothiazol-diyl group (hereinafter, abbreviated as “thienothiazol group”.

Among the divalent aromatic groups a divalent aromatic hydrocarbon group is preferable.

Here, it is also preferable that one of A¹, A², or A³ is a divalent thienothiazol group which may have a substituent. Here, specific examples of the substituent of the divalent thienothiazol group are the same as those of the substituent of “the divalent aromatic group which may have a substituent”, and a preferable aspect thereof is also the same.

In addition, It is more preferable that A² among A¹, A², and A³ represents a divalent thienothiazol group. In this case, A¹ and A² represent a divalent aromatic group which may have a substituent.

In a case where A² represents a divalent thienothiazol group, It is preferable that at least one of A¹ or A² represents a divalent aromatic hydrocarbon group which may have a substituent. It is preferable that both of A¹ and A² represent a divalent aromatic hydrocarbon group which may have a substituent.

In Formula (2), “substituent” represented by L¹ and L² will be described.

As the substituent, a group that is introduced in order to improve solubility or nematic liquid crystal properties, a group having electron-donating or electron-withdrawing properties that is introduced in order to adjust tone as a colorant, or a group having a crosslinking group (polymerizable group) that is introduced in order to immobilize alignment is preferable.

Examples of the substituent include an alkyl group, an alkenyl group, an alkynyl group, an aryl group, a substituted or unsubstituted amino group, an alkoxy group, an oxycarbonyl group, an acyloxy group, an acylamino group, an alkoxycarbonylamino group, an aryloxycarbonylamino group, a sulfonylamino group, a sulfamoyl group, a carbamoyl group, an alkylthio group, an arylthio group, a sulfonyl group, a sulfinyl group, an ureido group, a phosphoric amide group, a hydroxy group, a mercapto group, a halogen atom, a cyano group, a nitro group, a hydroxamic acid group, a sulfino group, a hydrazino group, an imino group, an azo group, a heterocyclic group, and a silyl group.

Specifically, the alkyl group is an alkyl group having preferably 1 to 20 carbon atoms, more preferably 1 to 12 carbon atoms, and still more preferably 1 to 8 carbon atoms, and examples thereof include a methyl group, an ethyl group, an isopropyl group, a tert-butyl group, an n-octyl group, an n-decyl group, an n-hexadecyl group, a cyclopropyl group, a cyclopentyl group, and a cyclohexyl group. The alkenyl group is an alkenyl group having preferably 2 to 20 carbon atoms, more preferably 2 to 12 carbon atoms, and still more preferably 2 to 8 carbon atoms, and examples thereof include a vinyl group, an aryl group, a 2-butenyl group, and a 3-pentenyl group. The alkynyl group is an alkynyl group having preferably 2 to 20 carbon atoms, more preferably 2 to 12 carbon atoms, and still more preferably 2 to 8 carbon atoms, and examples thereof include a propargyl group and a 3-pentynyl group. The aryl group is an aryl group having preferably 6 to 30 carbon atoms, more preferably 6 to 20 carbon atoms, and still more preferably 6 to 12 carbon atoms, and examples thereof include a phenyl group, a 2,6-diethylphenyl group, a 3,5-ditrifluoromethylphenyl group, a styryl group, a naphthyl group, and a biphenyl group. The substituted or unsubstituted amino group is an amino group having preferably 0 to 20 carbon atoms, more preferably 0 to 10 carbon atoms, still more preferably 0 to 6 carbon atoms, and examples thereof include an unsubstituted amino group, a methylamino group, a dimethylamino group, a diethylamino group, an anilino group. The alkoxy group is an alkoxy group having preferably 1 to 20 carbon atoms and more preferably 1 to 15 carbon atoms, and examples thereof include a methoxy group, an ethoxy group, and a butoxy group. The oxycarbonyl group is an oxycarbonyl group having preferably 2 to 20 carbon atoms, more preferably 2 to 15 carbon atoms, and still more preferably 2 to 10 carbon atoms, and examples thereof include a methoxycarbonyl group, an ethoxycarbonyl group, and a phenoxycarbonyl group. The acyloxy group is an acyloxy group having preferably from 2 to 20 carbon atoms, more preferably from 2 to 10 carbon atoms, and still more preferably from 2 to 6 carbon atoms, and examples thereof include an acetoxy group, a benzoyloxy group, an acryloyl group, and a methacryloyl group. The acylamino group is an acylamino group having preferably 2 to 20 carbon atoms, more preferably 2 to 10 carbon atoms, and still more preferably 2 to 6 carbon atoms, and examples thereof include an acetylamino group and a benzoylamino group. The alkoxycarbonylamino group is an alkoxycarbonylamino group having preferably 2 to 20 carbon atoms, more preferably 2 to 10 carbon atoms, and still more preferably 2 to 6 carbon atoms, and examples thereof include a methoxycarbonylamino group. The aryloxycarbonylamino group is an aryloxycarbonylamino group having preferably 7 to 20 carbon atoms, more preferably 7 to 16 carbon atoms, and still more preferably 7 to 12 carbon atoms, and examples thereof include a phenyloxycarbonylamino group. The sulfonylamino group is a sulfonylamino group having preferably 1 to 20 carbon atoms, more preferably 1 to 10 carbon atoms, and still more preferably 1 to 6 carbon atoms, and examples thereof include a methanesulfonylamino group and a benzenesulfonylamino group. The sulfamoyl group is a sulfamoyl group having preferably 0 to 20 carbon atoms, more preferably 0 to 10 carbon atoms, and still more preferably 0 to 6 carbon atoms, and examples thereof include a sulfamoyl group, a methylsulfamoyl group, a dimethylsulfamoyl group, and a phenylsulfamoyl group. The carbamoyl group is a carbamoyl group having preferably 1 to 20 carbon atoms, more preferably 1 to 10 carbon atoms, and still more preferably 1 to 6 carbon atoms, and examples thereof include an unsubstituted carbamoyl group, a methylcarbamoyl group, a diethylcarbamoyl group, and a phenylcarbamoyl group. The alkylthio group is an alkylthio group having preferably 1 to 20 carbon atoms, more preferably 1 to 10 carbon atoms, and still more preferably 1 to 6 carbon atoms, and examples thereof include a methylthio group and an ethylthio group. The arylthio group is an arylthio group having preferably 6 to 20 carbon atoms, more preferably 6 to 16 carbon atoms, and still more preferably 6 to 12 carbon atoms, and examples thereof include a phenylthio group. The sulfonyl group is a sulfonyl group having preferably 1 to 20 carbon atoms, more preferably 1 to 10 carbon atoms, and still more preferably 1 to 6 carbon atoms, and examples thereof include a mesyl group and a tosyl group. The sulfinyl group is a sulfinyl group having preferably 1 to 20 carbon atoms, more preferably 1 to 10 carbon atoms, and still more preferably 1 to 6 carbon atoms, and examples thereof include a methanesulfinyl group and a benzenesulfinyl group. The ureido group is an ureido group having preferably 1 to 20 carbon atoms, more preferably 1 to 10 carbon atoms, and still more preferably 1 to 6 carbon atoms, and examples thereof include an unsubstituted ureido group, a methylureido group, and a phenylureido group. The phosphoric amide group is a phosphoric amide group having preferably 1 to 20 carbon atoms, more preferably 1 to 10 carbon atoms, and still more preferably 1 to 6 carbon atoms, and examples thereof include a diethylphosphoric amide group and a phenylphosphoric amide group. Examples of the halogen atom include a fluorine atom, a chlorine atom, a bromine atom, and an iodine atom. The heterocyclic group is a heterocyclic group having preferably 1 to 30 carbon atoms, and more preferably 1 to 12 carbon atoms, a heterocyclic group having a heteroatom such as a nitrogen atom, an oxygen atom, or a sulfur atom can be used, and examples thereof include an epoxy group, an oxetanyl group, an imidazolyl group, a pyridyl group, a quinolyl group, a furyl group, a piperidyl group, a morpholino group, a benzoxazolyl group, a benzimidazolyl group, and a benzothiazolyl group. Further, the silyl group is a silyl group having preferably 3 to 40 carbon atoms, more preferably 3 to 30 carbon atoms, and still more preferably 3 to 24 carbon atoms, and examples thereof include a trimethylsilyl group and a triphenylsilyl group.

The substituents may be further substituted with the substituents. In addition, in a case where two or more substituents are present, the substituents may be the same as or different from each other. In addition, if possible, the substituents may be bonded to each other to form a ring.

Preferable examples of the substituent represented by L¹ and L² include an alkyl group which may have a substituent, an alkenyl group which may have a substituent, an alkynyl group which may have a substituent, an aryl group which may have a substituent, an alkoxy group which may have a substituent, an oxycarbonyl group which may have a substituent, an acyloxy group which may have a substituent, an acylamino group which may have a substituent, an amino group which may have a substituent, an alkoxycarbonylamino group which may have a substituent, a sulfonylamino group which may have a substituent, a sulfamoyl group which may have a substituent, a carbamoyl group which may have a substituent, an alkylthio group which may have a substituent, a sulfonyl group which may have a substituent, an ureido group which may have a substituent, a nitro group, a hydroxy group, a cyano group, an imino group, an azo group, a halogen atom, and a heterocyclic group. As the substituent represented by L¹ and L², an alkyl group which may have a substituent, an alkenyl group which may have a substituent, an aryl group which may have a substituent, an alkoxy group which may have a substituent, an oxycarbonyl group which may have a substituent, an acyloxy group which may have a substituent, an amino group which may have a substituent, a nitro group, an imino group, or an azo group is more preferable.

It is preferable that at least one of L¹ or L² has a crosslinking group (polymerizable group), and it is more preferable that both L¹ and L² have a crosslinking group.

Specific examples of the crosslinking group include a polymerizable group described in paragraphs “0040” to “0050” of JP2010-244038A. From the viewpoints of reactivity and synthesis suitability, an acryloyl group, a methacryloyl group, an epoxy group, an oxetanyl group, or a styryl group is preferable, and an acryloyl group or a methacryloyl group is more preferable.

Examples of a preferable aspect of L¹ and L² include an alkyl group substituted with the crosslinking group, a dialkylamino group substituted with the crosslinking group, and an alkoxy group substituted with the crosslinking group.

(Second Dichroic Colorant)

From the viewpoint that a high alignment degree on a long wavelength side can be achieved, it is preferable that the optically-anisotropic layer-forming composition includes a dichroic colorant represented by the following Formula (3).

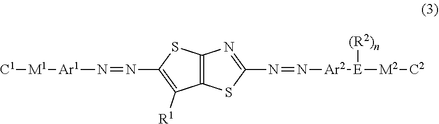

In Formula (3), C¹ and C² each independently represent a monovalent substituent. In this case, at least one of C¹ or C² represents a crosslinking group.

In Formula (3), M¹ and M² each independently represent a divalent linking group. The number of atoms in a main chain of at least one of M¹ or M² is 4 or more.

In Formula (3), Ar¹ and Ar² each independently represent any one of a phenylene group which may have a substituent, a naphthylene group which may have a substituent, or a biphenylene group which may have a substituent.

In Formula (3), E represents any one of a nitrogen atom, an oxygen atom, or a sulfur atom.

In Formula (3), R¹ represents a hydrogen atom or a substituent.

In Formula (3), R² represents a hydrogen atom or an alkyl group which may have a substituent.

In Formula (3), n represents 0 or 1. In a case where E represents a nitrogen atom, n represents 1. In a case where E represents an oxygen atom or a sulfur atom, n represents 0.

In Formula (3), the monovalent substituent represented by C¹ and C² will be described.

As the monovalent substituent represented by C¹ and C², a group that is introduced in order to improve solubility of an azo compound or nematic liquid crystal properties, a group having electron-donating or electron-withdrawing properties that is introduced in order to adjust tone as a colorant, or a group having a crosslinking group (polymerizable group) that is introduced in order to immobilize alignment is preferable.

Examples of the substituent include an alkyl group, an alkenyl group, an alkynyl group, an aryl group, a substituted or unsubstituted amino group, an alkoxy group, an oxycarbonyl group, an acyloxy group, an acylamino group, an alkoxycarbonylamino group, an aryloxycarbonylamino group, a sulfonylamino group, a sulfamoyl group, a carbamoyl group, an alkylthio group, an arylthio group, a sulfonyl group, a sulfinyl group, an ureido group, a phosphoric amide group, a hydroxy group, a mercapto group, a halogen atom, a cyano group, a nitro group, a hydroxamic acid group, a sulfino group, a hydrazino group, an imino group, an azo group, a heterocyclic group, and a silyl group.

Specifically, the alkyl group is an alkyl group having preferably 1 to 20 carbon atoms, more preferably 1 to 12 carbon atoms, and still more preferably 1 to 8 carbon atoms, and examples thereof include a methyl group, an ethyl group, an isopropyl group, a tert-butyl group, an n-octyl group, an n-decyl group, an n-hexadecyl group, a cyclopropyl group, a cyclopentyl group, and a cyclohexyl group. The alkenyl group is an alkenyl group having preferably 2 to 20 carbon atoms, more preferably 2 to 12 carbon atoms, and still more preferably 2 to 8 carbon atoms, and examples thereof include a vinyl group, an aryl group, a 2-butenyl group, and a 3-pentenyl group. The alkynyl group is an alkynyl group having preferably 2 to 20 carbon atoms, more preferably 2 to 12 carbon atoms, and still more preferably 2 to 8 carbon atoms, and examples thereof include a propargyl group and a 3-pentynyl group. The aryl group is an aryl group having preferably 6 to 30 carbon atoms, more preferably 6 to 20 carbon atoms, and still more preferably 6 to 12 carbon atoms, and examples thereof include a phenyl group, a 2,6-diethylphenyl group, a 3,5-ditrifluoromethylphenyl group, a styryl group, a naphthyl group, and a biphenyl group. The substituted or unsubstituted amino group is an amino group having preferably 0 to 20 carbon atoms, more preferably 0 to 10 carbon atoms, still more preferably 0 to 6 carbon atoms, and examples thereof include an unsubstituted amino group, a methylamino group, a dimethylamino group, a diethylamino group, an anilino group. The alkoxy group is an alkoxy group having preferably 1 to 20 carbon atoms and more preferably 1 to 15 carbon atoms, and examples thereof include a methoxy group, an ethoxy group, and a butoxy group. The oxycarbonyl group is an oxycarbonyl group having preferably 2 to 20 carbon atoms, more preferably 2 to 15 carbon atoms, and still more preferably 2 to 10 carbon atoms, and examples thereof include a methoxycarbonyl group, an ethoxycarbonyl group, and a phenoxycarbonyl group. The acyloxy group is an acyloxy group having preferably from 2 to 20 carbon atoms, more preferably from 2 to 10 carbon atoms, and still more preferably from 2 to 6 carbon atoms, and examples thereof include an acetoxy group, a benzoyloxy group, an acryloyl group, and a methacryloyl group. The acylamino group is an acylamino group having preferably 2 to 20 carbon atoms, more preferably 2 to 10 carbon atoms, and still more preferably 2 to 6 carbon atoms, and examples thereof include an acetylamino group and a benzoylamino group. The alkoxycarbonylamino group is an alkoxycarbonylamino group having preferably 2 to 20 carbon atoms, more preferably 2 to 10 carbon atoms, and still more preferably 2 to 6 carbon atoms, and examples thereof include a methoxycarbonylamino group. The aryloxycarbonylamino group is an aryloxycarbonylamino group having preferably 7 to 20 carbon atoms, more preferably 7 to 16 carbon atoms, and still more preferably 7 to 12 carbon atoms, and examples thereof include a phenyloxycarbonylamino group. The sulfonylamino group is a sulfonylamino group having preferably 1 to 20 carbon atoms, more preferably 1 to 10 carbon atoms, and still more preferably 1 to 6 carbon atoms, and examples thereof include a methanesulfonylamino group and a benzenesulfonylamino group. The sulfamoyl group is a sulfamoyl group having preferably 0 to 20 carbon atoms, more preferably 0 to 10 carbon atoms, and still more preferably 0 to 6 carbon atoms, and examples thereof include a sulfamoyl group, a methylsulfamoyl group, a dimethylsulfamoyl group, and a phenylsulfamoyl group. The carbamoyl group is a carbamoyl group having preferably 1 to 20 carbon atoms, more preferably 1 to 10 carbon atoms, and still more preferably 1 to 6 carbon atoms, and examples thereof include an unsubstituted carbamoyl group, a methylcarbamoyl group, a diethylcarbamoyl group, and a phenylcarbamoyl group. The alkylthio group is an alkylthio group having preferably 1 to 20 carbon atoms, more preferably 1 to 10 carbon atoms, and still more preferably 1 to 6 carbon atoms, and examples thereof include a methylthio group and an ethylthio group. The arylthio group is an arylthio group having preferably 6 to 20 carbon atoms, more preferably 6 to 16 carbon atoms, and still more preferably 6 to 12 carbon atoms, and examples thereof include a phenylthio group. The sulfonyl group is a sulfonyl group having preferably 1 to 20 carbon atoms, more preferably 1 to 10 carbon atoms, and still more preferably 1 to 6 carbon atoms, and examples thereof include a mesyl group and a tosyl group. The sulfinyl group is a sulfinyl group having preferably 1 to 20 carbon atoms, more preferably 1 to 10 carbon atoms, and still more preferably 1 to 6 carbon atoms, and examples thereof include a methanesulfinyl group and a benzenesulfinyl group. The ureido group is an ureido group having preferably 1 to 20 carbon atoms, more preferably 1 to 10 carbon atoms, and still more preferably 1 to 6 carbon atoms, and examples thereof include an unsubstituted ureido group, a methylureido group, and a phenylureido group. The phosphoric amide group is a phosphoric amide group having preferably 1 to 20 carbon atoms, more preferably 1 to 10 carbon atoms, and still more preferably 1 to 6 carbon atoms, and examples thereof include a diethylphosphoric amide group and a phenylphosphoric amide group. Examples of the halogen atom include a fluorine atom, a chlorine atom, a bromine atom, and an iodine atom. The heterocyclic group is a heterocyclic group having preferably 1 to 30 carbon atoms, and more preferably 1 to 12 carbon atoms, a heterocyclic group having a heteroatom such as a nitrogen atom, an oxygen atom, or a sulfur atom can be used, and examples thereof include an epoxy group, an oxetanyl group, an imidazolyl group, a pyridyl group, a quinolyl group, a furyl group, a piperidyl group, a morpholino group, a benzoxazolyl group, a benzimidazolyl group, and a benzothiazolyl group. Further, the silyl group is a silyl group having preferably 3 to 40 carbon atoms, more preferably 3 to 30 carbon atoms, and still more preferably 3 to 24 carbon atoms, and examples thereof include a trimethylsilyl group and a triphenylsilyl group.

The substituents may be further substituted with the substituents. In addition, in a case where two or more substituents are present, the substituents may be the same as or different from each other. In addition, if possible, the substituents may be bonded to each other to form a ring.

In Formula (3), at least one of C¹ or C² represents a crosslinking group. From the viewpoint of further improving the durability of the optically-anisotropic layer, it is preferable that both C¹ and C² represent a crosslinking group.

Specific examples of the crosslinking group include a polymerizable group described in paragraphs “0040” to “0050” of JP2010-244038A. From the viewpoints of reactivity and synthesis suitability, an acryloyl group, a methacryloyl group, an epoxy group, an oxetanyl group, or a styryl group is preferable, and an acryloyl group or a methacryloyl group is more preferable.

In Formula (3), the divalent linking group represented by M¹ and M² will be described.

Examples of the divalent linking group include —O—, —S—, —CO—, —COO—, —OCO—, —O—CO—O—, —CO—NR^{N}—, —O—CO—NR^{N}—, —SO₂—, —SO—, an alkylene group, a cycloalkylene group, an alkenylene group, a group including a combination of two or more kinds thereof.

Among these, a group including a combination of an alkylene group and one or more selected from the group consisting of —O—, —S—, —CO—, —COO—, —OCO—, —O—CO—O—, —CO—NR^{N}—, —O—CO—NR^{N}—, —SO₂—, and —SO— is preferable. R^{N} represents a hydrogen atom or an alkyl group.

In addition, the number of atoms in a main chain of at least one of M¹ or M² is 4 or more, preferably 7 or more, and more preferably 10 or more. In addition, the upper limit value of the number of atoms in the main chain is preferably 20 or less and more preferably 15 or less.

Here, “main chain” in M¹ refers to a portion required for direct connection between “C¹” and “Ar¹” in Formula (3), and “the number of atoms in the main chain” refers to the number of atoms forming the above-described portion. Likewise, “main chain” in M² refers to a portion required for direct connection between “C²” and “E” in Formula (3), and “the number of atoms in the main chain” refers to the number of atoms forming the above-described portion. “The number of atoms in the main chain” does not include the number of atoms in a branched chain described below.

Specifically, in the following Formula (D7), the number of atoms in the main chain of M1 is 6 (the number of atoms in a frame indicated by a dotted line on the left side of the following Formula (D7)), and the number of atoms in the main chain of M2 is 7 (the number of atoms in a frame indicated by a dotted line on the right side of the following Formula (D7)).

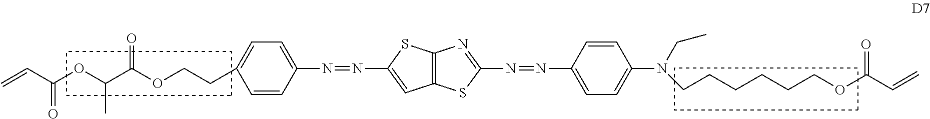 [SMILES: C=CC(=O)OCCCCCCN(CC)c1ccc(N=Nc2nc3sc(N=Nc4ccc(CCOC(=O)C(C)OC(=O)C=C)cc4)cc3s2)cc1]

In the present invention, in at least one of M¹ or M², the number of atoms in the main chain only has to be 4 or more. As long as the number of atoms in the main chain of one of M¹ or M² is 4 or more, the number of atoms in the main chain in another one of M¹ or M² may be 3 or less.

The total number of atoms in the main chains of M¹ and M² is preferably 5 to 30 and more preferably 7 to 27. By setting the total number of atoms in the main chains to be 5 or more, the dichroic colorant is more likely to be polymerized. By setting the total number of atoms in the main chains to be 30 or less, an optically-anisotropic layer having a high alignment degree can be easily obtained, the melting point of the dichroic colorant increases, and an optically-anisotropic layer having high heat resistance can be easily obtained.

M¹ and M² may have a branched chain. Here, “branched chain” in M¹ refers to a portion other than the portion required for direct connection between C¹ and Ar¹ in Formula (3). Likewise, “branched chain” in M² refers to a portion other than the portion required for direct connection between C² and E in Formula (3).

The number of atoms in the branched chain is preferably 3 or less. By setting the number of atoms in the branched chain to be 3 or less, there is an advantageous effect in that the alignment degree of the optically-anisotropic layer is further improved. The number of atoms in the branched chain does not include the number of hydrogen atoms.

Hereinafter, preferable structures of M¹ and M² will be shown, but the present invention is not limited thereto. In the following structures, “*” represents a linking portion between C¹ and Ar¹ or a linking portion between C² and E.

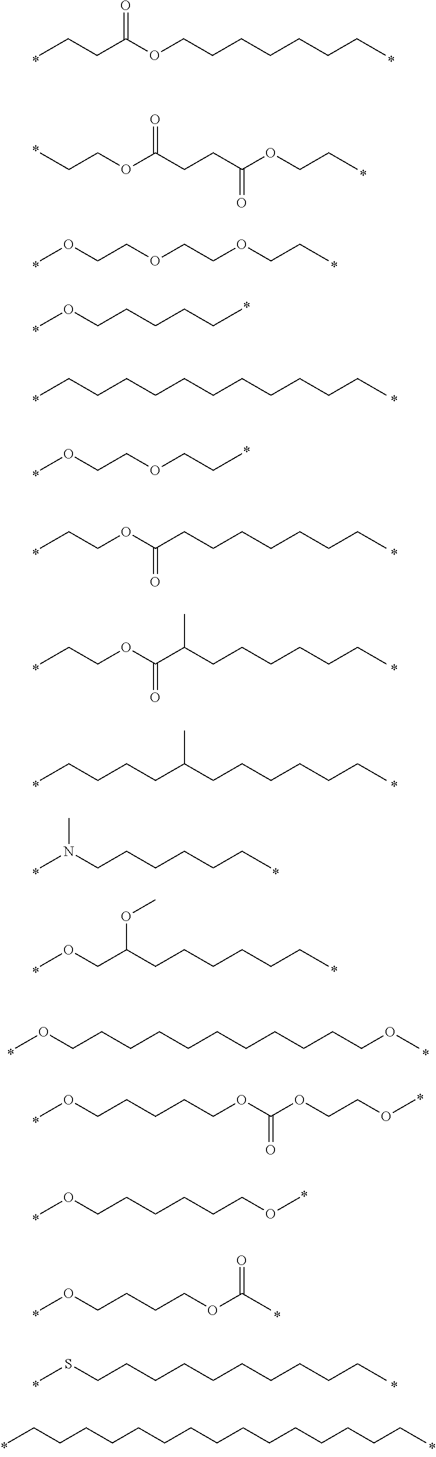

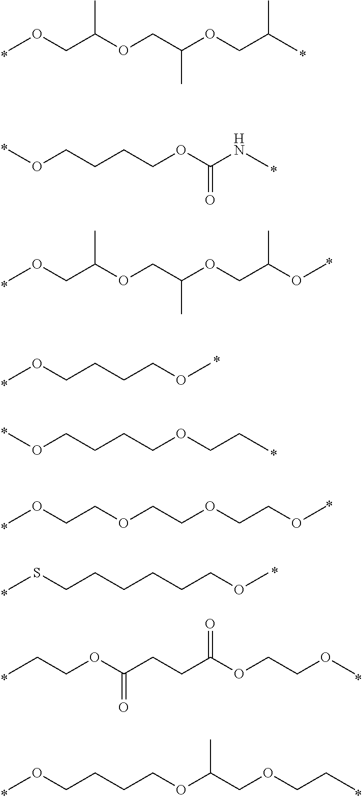

In the present invention, from the viewpoint of improving alignment degree, it is necessary that M¹ has an oxygen atom.

“The phenylene group which may have a substituent”, “the naphthylene group which may have a substituent” and “the biphenylene group which may have a substituent” represented by Ar¹ and Ar² in Formula (3) will be described.

The substituent is not particularly limited, and examples thereof include a halogen atom, an alkyl group, an alkyloxy group, an alkylthio group, an oxycarbonyl group, a thioalkyl group, an acyloxy group, an acylamino group, an alkoxycarbonylamino group, a sulfonylamino group, a sulfamoyl group, a carbamoyl group, a sulfinyl group, and an ureido group. The substituents may be further substituted with the substituents. In particular, an alkyl group is preferable, an alkyl group having 1 to 5 carbon atoms is still more preferable, and a methyl group or an ethyl group is preferable from the viewpoints of easy availability of raw materials and alignment degree.

Ar¹ and Ar² represent a phenylene group which may have a substituent, a naphthylene group which may have a substituent, or a biphenylene group which may have a substituent. From the viewpoints of easy availability of raw materials which may have a substituent and alignment degree, a phenylene group is preferable.

It is preferable that “M¹” and “N” linked to Ar¹ in Formula (3) is positioned in the para position of Ar¹. It is preferable that “E” and “N” linked to Ar² is positioned in the para position of Ar¹.

In Formula (3), E represents any one of a nitrogen atom, an oxygen atom, or a sulfur atom. From the viewpoint of synthesis suitability, it is preferable that E represents a nitrogen atom.

In addition, from the viewpoint of easily adjusting the dichroic colorant to have absorption on a short wavelength side (for example, having a maximum absorption wavelength at about 500 to 530 nm, it is preferable that E in Formula (3) represents an oxygen atom.

On the other hand, from the viewpoint of easily adjusting the dichroic colorant to have absorption on a long wavelength side (for example, having a maximum absorption wavelength at about 600 nm, it is preferable that E in Formula (3) represents a nitrogen atom.

In Formula (3), R¹ represents a hydrogen atom or a substituent.

Since specific examples and a preferable aspect of “substituent” represented by R¹ are the same as those of the substituent represented by Ar¹ and Ar², the description thereof will not be repeated.

In Formula (3), R² represents a hydrogen atom or an alkyl group which may have a substituent and preferably an alkyl group which may have a substituent.

Examples of the substituent include a halogen atom, a hydroxyl group, an ester group, an ether group, and a thioether group.

Examples of the alkyl group include a linear, branched, or cyclic alkyl group having 1 to 8 carbon atoms. In particular, a linear alkyl group having 1 to 6 carbon atoms is preferable, a linear alkyl group having 1 to 3 carbon atoms is more preferable, and a methyl group or an ethyl group is still more preferable.

In a case where E represents a nitrogen atom, R² represents a group present in Formula (3) (that is, n=1). On the other hand, in a case where E represents an oxygen atom or a sulfur atom, R² represents a group not present in Formula (3) (that is, n=0).

In Formula (3), n represents 0 or 1. In a case where E represents a nitrogen atom, n represents 1. In a case where E represents an oxygen atom or a sulfur atom, n represents 0.

Hereinafter, specific examples of the dichroic colorant in Formula (3) will be shown below, but the present invention is not limited thereto.

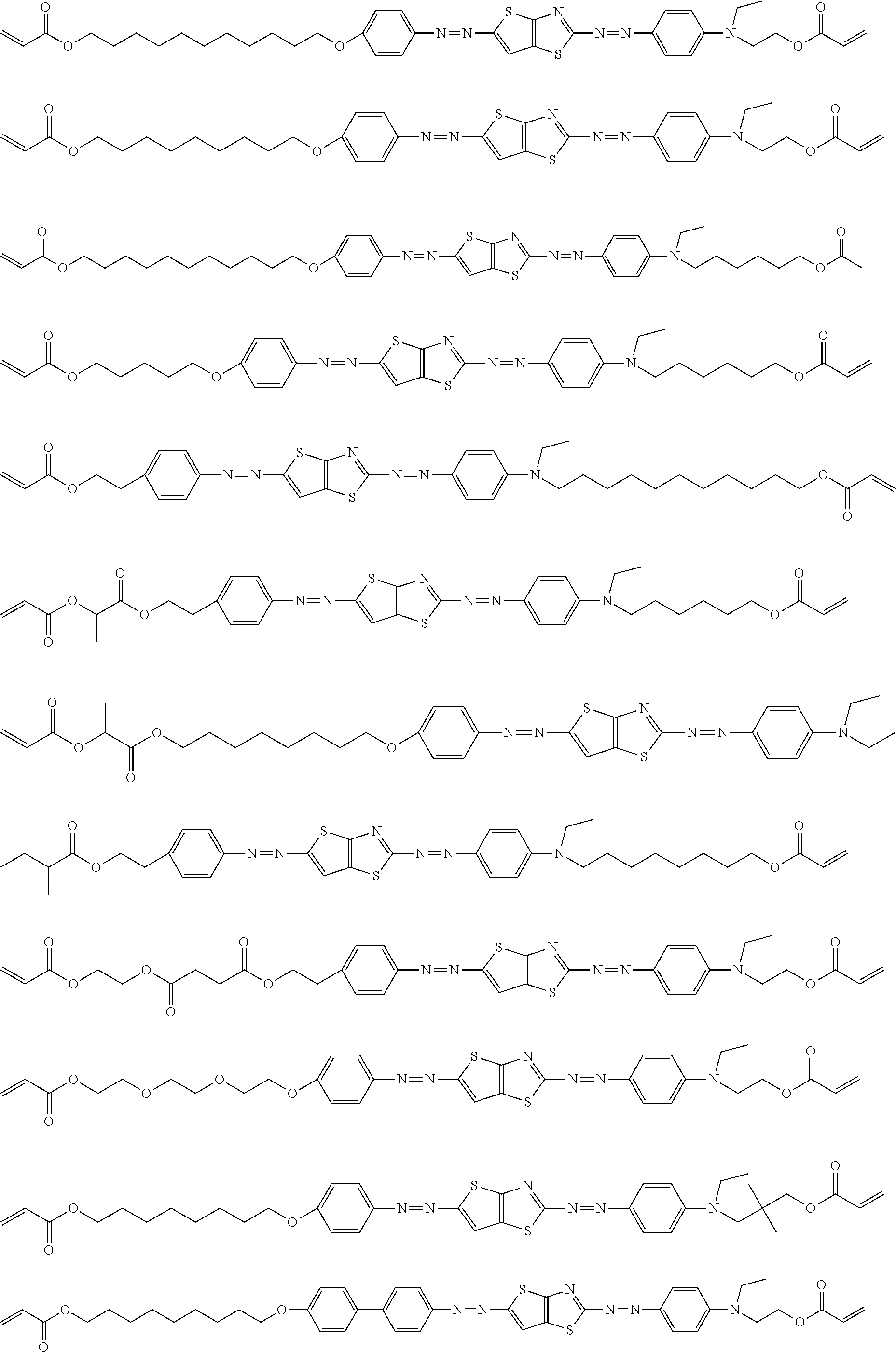

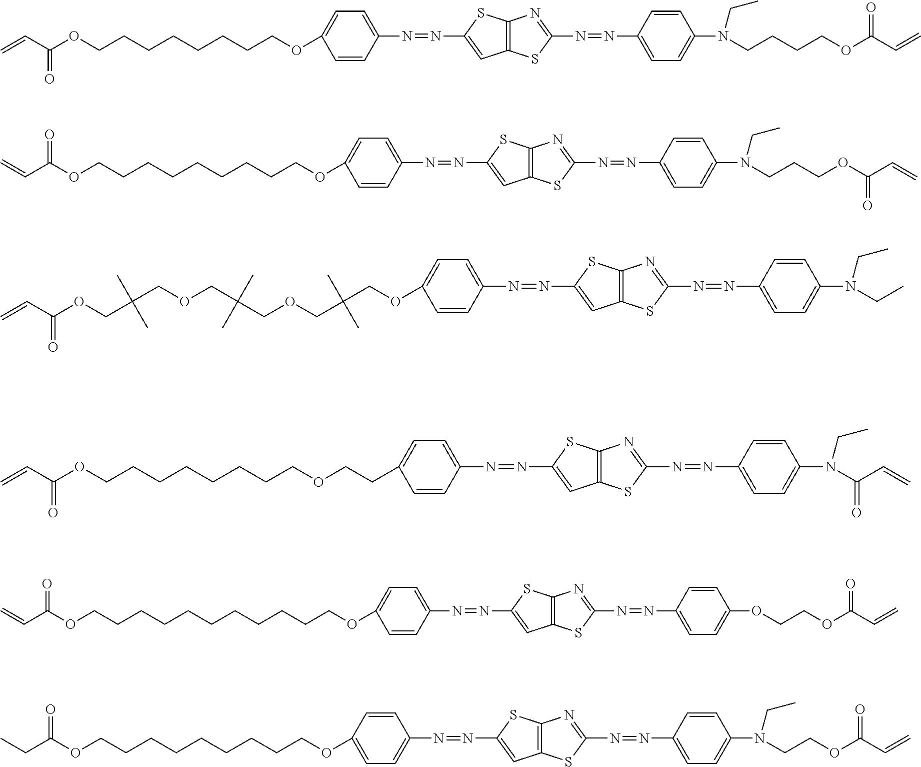

(First Dichroic Colorant)

From the viewpoint that a high alignment degree on a short wavelength side can be achieved, it is preferable that the optically-anisotropic layer-forming composition includes a dichroic colorant represented by the following Formula (4).

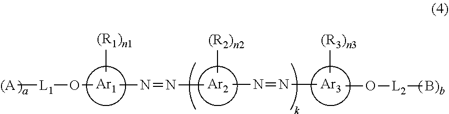

In Formula (4), A and B each independently represent a crosslinking group.

In Formula (4), a and b each independently represent 0 or 1. In this case, a+b≥1.

In Formula (4), in a case where a=0, L₁ represents a monovalent substituent. In a case where a=1, L₁ represents a single bond or a divalent linking group. In addition, in a case where b=0, L₂ represents a monovalent substituent. In a case where b=1, L₂ represents a single bond or a divalent linking group.

In Formula (4), Ar₁ represents a (n1+2)valent aromatic hydrocarbon group or a heterocyclic group, Ar₂ represents a (n2+2)valent aromatic hydrocarbon group or a heterocyclic group, and Ar₃ represents a (n3+2)valent aromatic hydrocarbon group or a heterocyclic group.

In Formula (4), R₁, R₂, and R₃ each independently represent a monovalent substituent. In a case where n1≥2, a plurality of R₁ may be the same as or different from each other. In a case where n2≥2, a plurality of R₂ may be the same as or different from each other. In a case where n3≥2, a plurality of R₃ may be the same as or different from each other.

In Formula (4), k represents an integer of 1 to 4. In a case where k≥2, a plurality of Ar₂'s may be the same as or different from each other, and a plurality of R₂'s may be the same as or different from each other.

In Formula (4), n1, n2, and n3 each independently represent an integer of 0 to 4. In a case where k=1, n1+n2+n3≥0. In a case where k=2, n1+n2+n3≥1.

Formula (4) is the same as Formula (1) in WO2017/195833A, and the details may refer thereto.

Hereinafter, specific examples of the dichroic colorant in Formula (4) will be shown, but the present invention is not limited thereto. In the following specific examples, n represents an integer of 1 to 10.

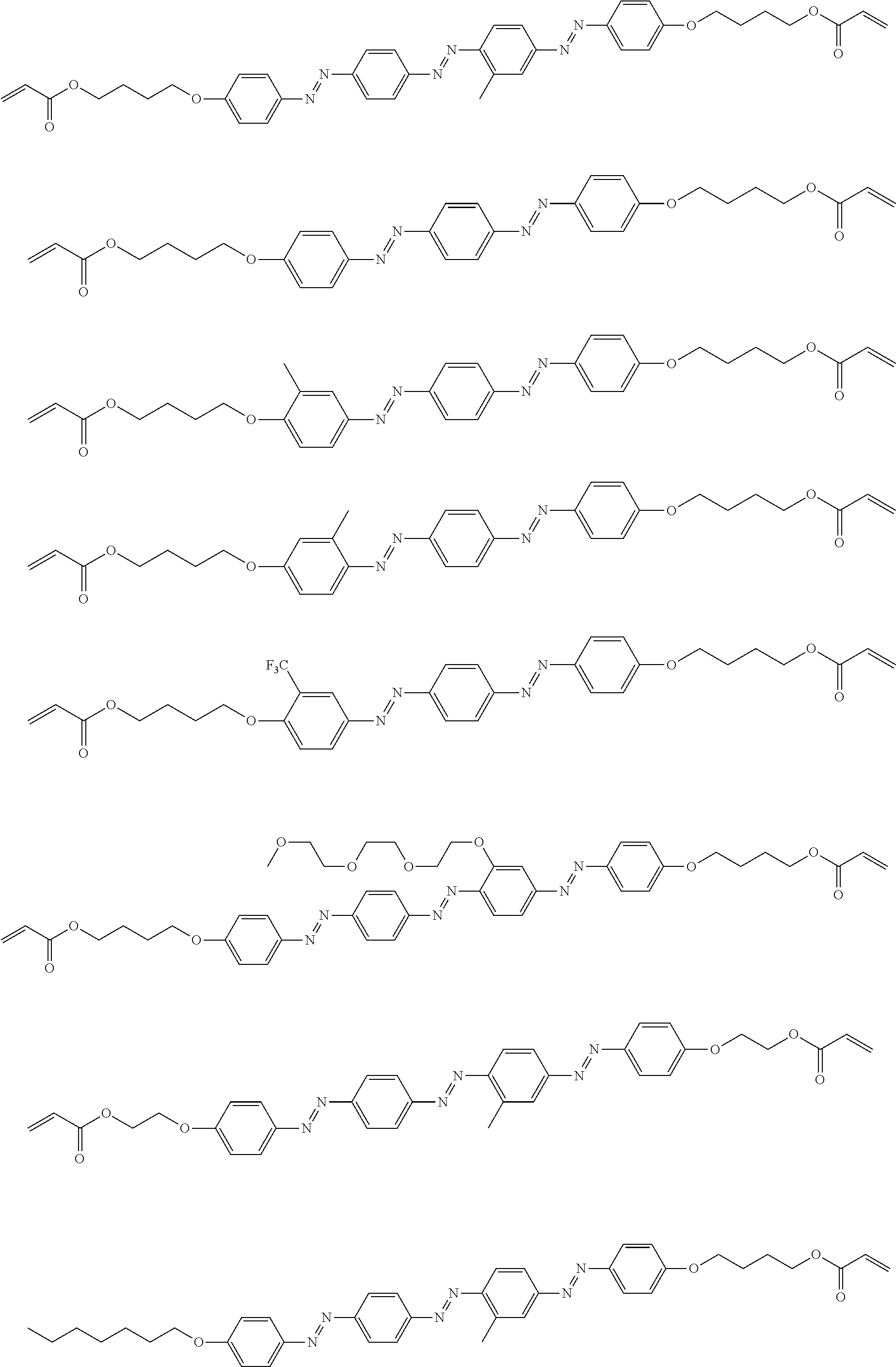

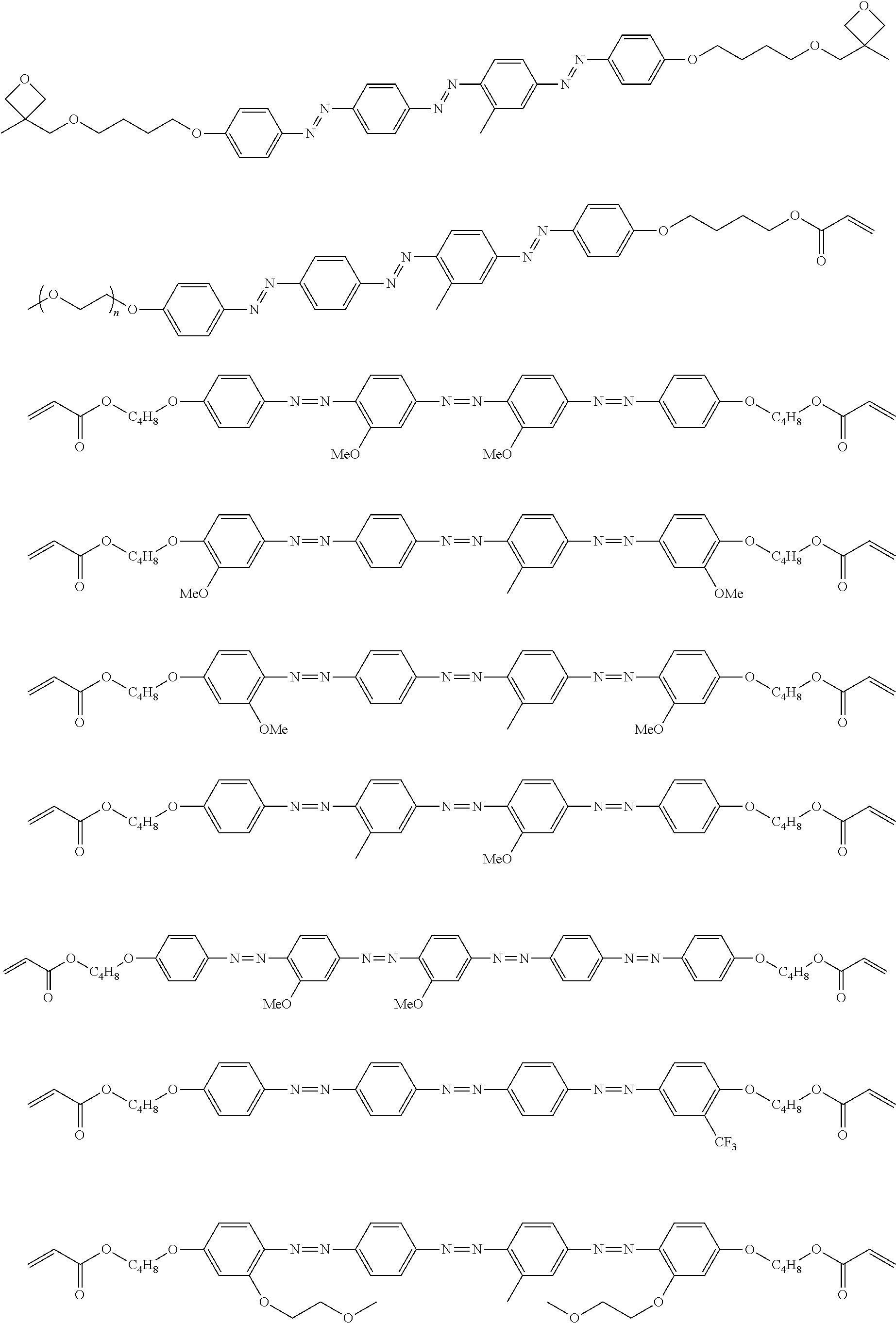

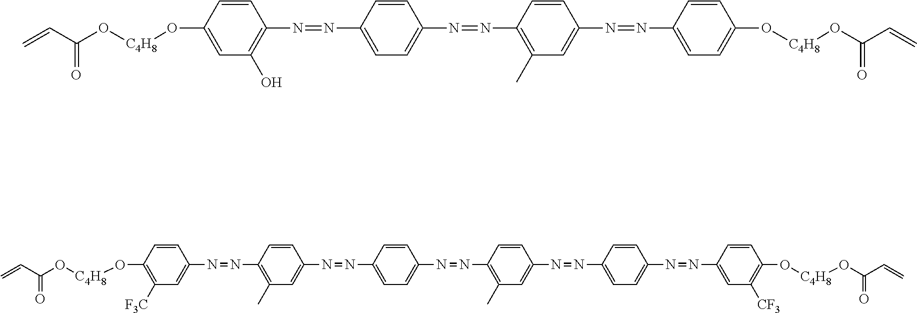

In the present invention, the content of the dichroic colorant in the optically-anisotropic layer-forming composition is not particularly limited. That is, in the present invention, the content of the dichroic colorant in the optically-anisotropic layer is not limited. Accordingly, the content of the dichroic colorant in the optically-anisotropic layer-forming composition may be appropriately set depending on the kind of the liquid crystal compound, the kind of the dichroic colorant, and the like in the optically-anisotropic layer-forming composition.

From the viewpoint of improving the alignment degree of the dichroic colorant, the ratio of the content the dichroic colorant to the content of the liquid crystal compound is preferably 5% to 25 mass %. The ratio of the content of the dichroic colorant to the content of the liquid crystal compound is more preferably 5% to 20 mass % and still more preferably 8% to 18 mass %.

<Liquid Crystal Compound>

The optically-anisotropic layer-forming composition includes the liquid crystal compound. By the optically-anisotropic layer-forming composition including the liquid crystal compound, the dichroic colorant can be aligned with a high alignment degree while suppressing precipitation of the dichroic colorant.

The liquid crystal compound in the present invention is a liquid crystal compound that is not dichroic.

As the liquid crystal compound, any one of a low-molecular-weight liquid crystal compound or a high-molecular-weight liquid crystal compound can be used. Here, “low-molecular-weight liquid crystal compound” refers to a liquid crystal compound not including a repeating unit in a chemical structure. In addition, “high-molecular-weight liquid crystal compound” refers to a liquid crystal compound including a repeating unit in a chemical structure.

Examples of the low-molecular-weight liquid crystal compound include a liquid crystal compound described in JP2013-228706A.

Examples of the high-molecular-weight liquid crystal compound include a thermotropic liquid crystalline polymer described in JP2011-237513A. In addition, the high-molecular-weight liquid crystal compound may have a crosslinking group (for example, an acryloyl group or a methacryloyl group) at a terminal.

As the liquid crystal compound, one kind may be used alone, or two or more kinds may be used in combination.

In a case where the liquid crystal compound is included, the content of the liquid crystal compound is preferably 75 to 95 parts by mass, more preferably 75 to 90 parts by mass, and still more preferably 80 to 90 parts by mass as a solid content ratio. In a case where the content of the liquid crystal compound is in the above-described range, the alignment degree of the optically-anisotropic layer is further improved.

(Low-Molecular-Weight Liquid Crystal Compound)

It is preferable that the low-molecular-weight liquid crystal compound included in the optically-anisotropic layer-forming composition is represented by the following Formula (5).

U1-V1-W1-X1-Y1-X2-Y2-X3-W2-V2-U2 (5)

[In Formula (5), X1, X2, and X3 each independently represent a 1,4-phenylene group which may have a substituent or a cyclohexane-1,4-diyl group which may have a substituent. At least one of X1, X2, or X3 represent a 1,4-phenylene group which may have a substituent. —CH₂ forming the cyclohexane-1,4-diyl group may be replaced with —O—, —S—, or NR—. R represents an alkyl group having 1 to 6 carbon atoms or a phenyl group.

Y1 and Y2 each independently represent —CH₂CH₂—, —CH₂O—, —COO—, —OCOO—, a single bond, —N═N—, —CRa═CRb—, —C≡C—. or CRa═N—. Ra and Rb each independently represent a hydrogen atom or an alkyl group having 1 to 4 carbon atoms.

U1 represents a hydrogen atom or a polymerizable group.

U2 represents a polymerizable group.

W1 and W2 each independently represent a single bond, —O—, —S—, —COO—, or OCOO—.

V1 and V2 each independently represent an alkanediyl group having 1 to 20 carbon atoms which may have a substituent, and —CH2 forming the alkanediyl group may be replaced with —O—, —S—, or NH—.]

Formula (5) is the same as Formula (A) in JP2017-083843A, and the details may refer thereto.

Specific examples of the low-molecular-weight liquid crystal compound include compounds represented by Formulae (B-1) to (B-25). In a case where the low-molecular-weight liquid crystal compound has a cyclohexane-1,4-diyl group, it is preferable that the cyclohexane-1,4-diyl group is a trans isomer.

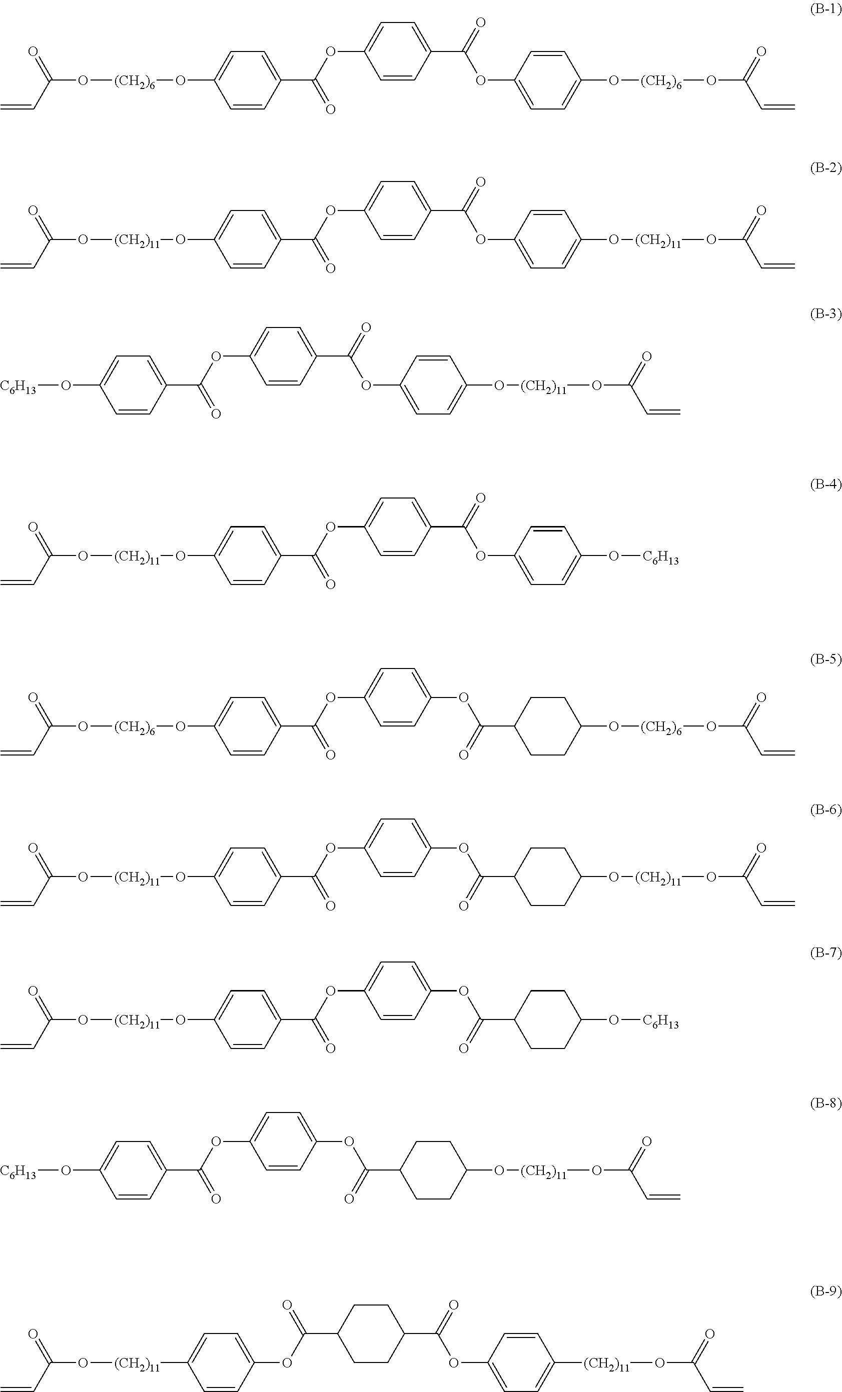

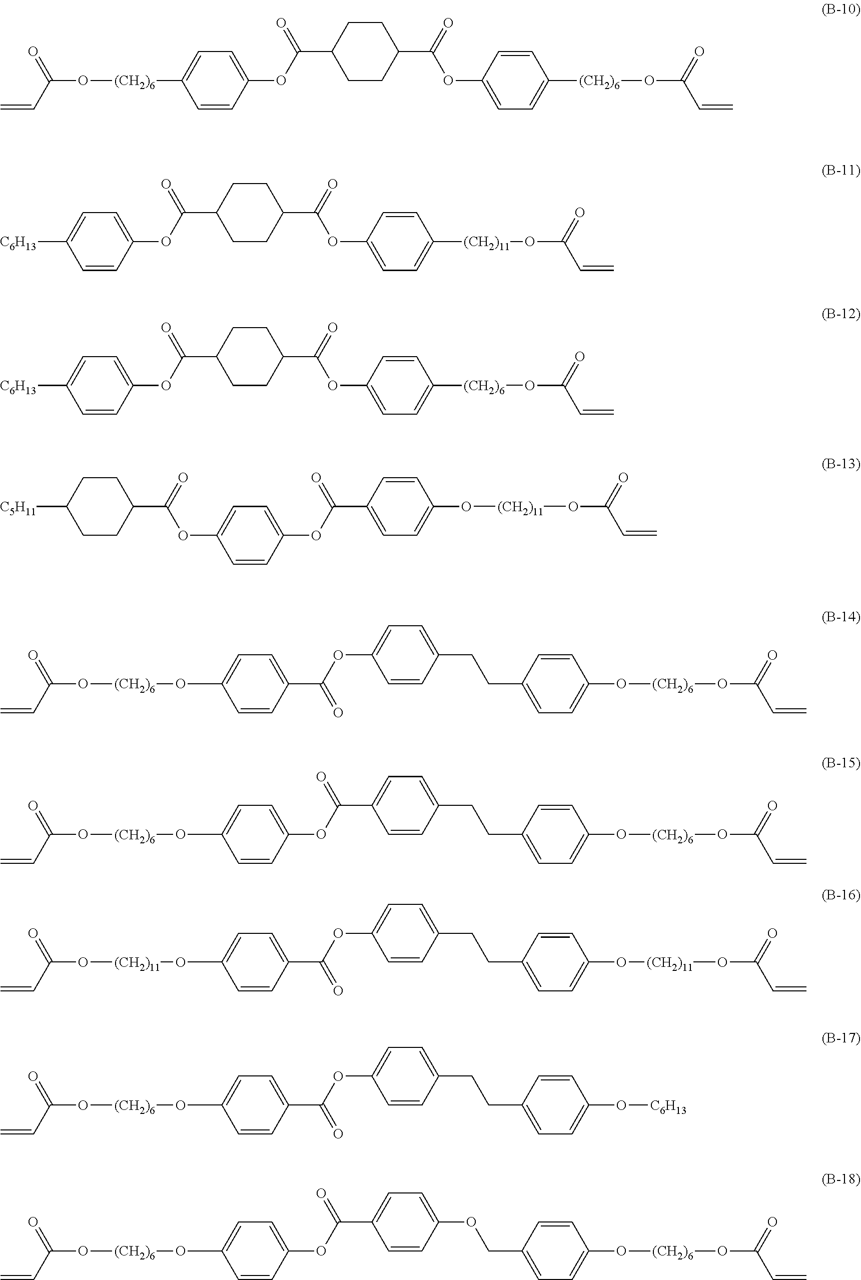

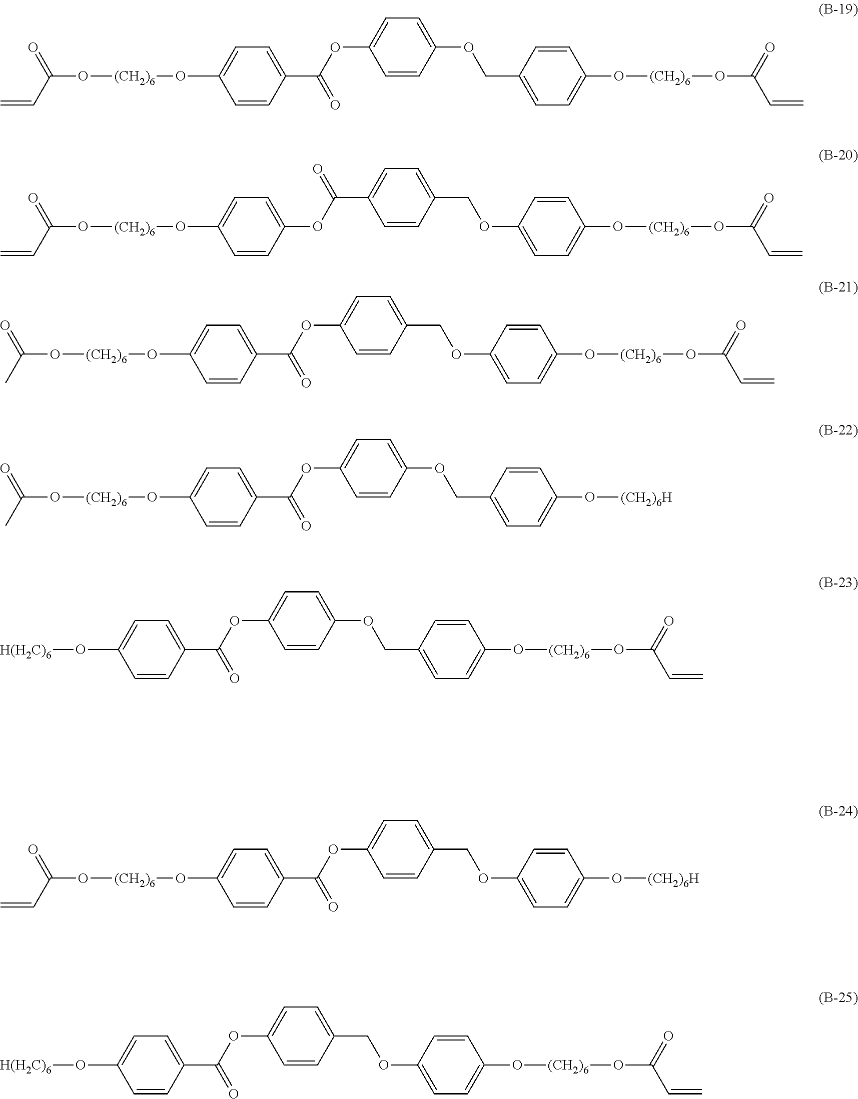

In particular, it is preferable that at least one selected from the group consisting of the compounds represented by Formula (B-2), Formula (B-3), Formula (B-4), Formula (B-5), Formula (B-6), Formula (B-7), Formula (B-8), Formula (B-13), Formula (B-14), Formula (B-15), Formula (B-16), and Formula (B-17).

The exemplary low-molecular-weight liquid crystal compounds can be used alone or in combination. In addition, in a case where two or more low-molecular-weight liquid crystal compounds are used in combination, it is preferable that at least one kind is a low-molecular-weight liquid crystal compound, and it is more preferable that two or more kinds are low-molecular-weight liquid crystal compounds. By using two or more low-molecular-weight liquid crystal compounds in combination, there may be a case where liquid crystal properties can be temporarily maintained even at a temperature lower than or equal to a liquid crystal-crystal phase transition temperature. In a case where two or more low-molecular-weight liquid crystal compounds are used in combination, a mixing ratio therebetween is typically 1:99 to 50:50, preferably 5:95 to 50:50, and more preferably 10:90 to 50:50.

The liquid crystal state in the low-molecular-weight liquid crystal compound is preferably a smectic phase. From the viewpoint that a polarizing layer having a higher alignment order parameter can be manufactured, the liquid crystal state in the low-molecular-weight liquid crystal compound is more preferably a higher-order smectic phase. “Higher-order smectic phase” refers to a smectic B phase, a smectic D phase, a smectic E phase, a smectic F phase, a smectic G phase, a smectic H phase, a smectic I phase, a smectic J phase, a smectic K phase, or a smectic L phase. In particular, a smectic B phase, a smectic F phase, or a smectic I phase is more preferable.

In the polarizing layer having a high order parameter, a Bragg peak derived from a higher order structure such as a hexatic phase or a crystal phase can be obtained in X-ray diffraction. “Bragg peak” refers to a peak derived from a plan periodic structure of molecular alignment, and a polarizing layer having a period interval of 3.0 to 5.0 Å is preferable.

The low-molecular-weight liquid crystal compound can be manufactured using a well-known method described in, for example, Lub et al. Recl. Tray. Chim. Pays-Bas, 115, 321-328 (1996) or JP4719156B.

(High-Molecular-Weight Liquid Crystal Compound)

It is preferable that the optically-anisotropic layer-forming composition according to the embodiment of the present invention includes the high-molecular-weight liquid crystal compound.

As the structure of the high-molecular-weight liquid crystal compound, a high-molecular-weight liquid crystal compound including a repeating unit represented by Formula (6) described below is preferable.

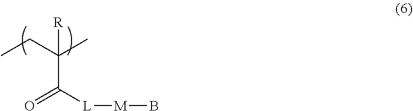

Here, in Formula (6),

R represents a hydrogen atom or a methyl group,

L represents a single bond or a divalent linking group,

B represents a hydrogen atom, a halogen atom, a cyano group, an alkyl group, an alkoxy group, an amino group, an oxycarbonyl group, an acyloxy group, an acylamino group, an alkoxycarbonylamino group, a sulfonylamino group, a sulfamoyl group, a carbamoyl group, an alkylthio group, a sulfonyl group, a sulfinyl group, an ureido group, or a crosslinking group, and

M represents a mesogen group represented by the following Formula (1-1).

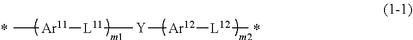

Here, in Formula (1-1),

Ar¹¹ and Ar¹² each independently represent a phenylene group which may have a substituent or a biphenylene group,

L¹¹ and L¹² each independently represent a single bond or a divalent linking group,

Y represents an imino group, a —OCO—CH═CH— group, or a —CH═CH—CO₂ group,

m1 and m2 each independently represent an integer of 1 to 3,

in a case where m1 represents an integer of 2 or 3, a plurality of Ar¹¹'s may be the same as or different from each other and a plurality of L¹¹'s may be the same as or different from each other,

in a case where m2 represents an integer of 2 or 3, a plurality of Ar¹²'s may be the same as or different from each other and a plurality of L¹²'s may be the same as or different from each other, and

an azo group is not included as a linking group in M.

The divalent linking group represented by L in Formula (6) will be described.

Examples of the divalent linking group include —O—, —S—, —COO—, —COO—, —O—CO—O—, —NR^{N}CO—, —CONR^{N}—, an alkylene group, or a divalent group including a combination of two or more kinds thereof. R^{N} represents a hydrogen atom or an alkyl group.

Among these, a divalent group including a combination of one or more selected from the group consisting of —O—, —COO—, and —OCO— and an alkylene group is preferable.

In addition, from the viewpoint that the high-molecular-weight compound exhibits liquid crystal properties, the number of carbon atoms in the alkylene group is preferably 2 to 16.

The mesogen group represented by M in Formula (6) and represented by Formula (1-1) will be described. In Formula (1-1), * represents a binding site to L or B in Formula (6).

In Formula (1-1), Ar¹¹ and Ar¹² each independently represent a phenylene group which may have a substituent or a biphenylene group.

Here, the substituent is not particularly limited, and examples thereof include a halogen atom, an alkyl group, an alkyloxy group, an alkylthio group, an oxycarbonyl group, a thioalkyl group, an acyloxy group, an acylamino group, an alkoxycarbonylamino group, a sulfonylamino group, a sulfamoyl group, a carbamoyl group, a sulfinyl group, and an ureido group.

In Formula (1-1), L¹¹ and L¹² each independently represent a single bond or a divalent linking group.

Here, examples of the divalent linking group include —O—, —S—, —COO—, —OCO—, —O—CO—O—, —NR^{N}CO—, —CONR^{N}—, an alkylene group, or a divalent group including a combination of two or more kinds thereof. R^{N} represents a hydrogen atom or an alkyl group.

In Formula (1-1), Y represents an imino group, a —OCO—CH═CH— group, or a —CH═CH—CO₂ group.

In Formula (1-1), m1 and m2 each independently represent an integer of 1 to 3.

Here, from the viewpoint that the high-molecular-weight compound exhibits liquid crystal properties, m1 and m2 represent preferably an integer of 2 to 5 in total and more preferably an integer of 2 to 4 in total.

B in Formula (6) will be described.

B represents a hydrogen atom, a halogen atom, a cyano group, an alkyl group, an alkoxy group, an amino group, an oxycarbonyl group, an alkoxycarbonyl group, an acyloxy group, a (poly)alkyleneoxy group, an acylamino group, an alkoxycarbonylamino group, a sulfonylamino group, a sulfamoyl group, a carbamoyl group, an alkylthio group, a sulfonyl group, a sulfinyl group, or an ureido group.

Among these, from the viewpoint of exhibiting the liquid crystal properties of the high-molecular-weight compound or adjusting the phase transition temperature and the viewpoint of solubility, a cyano group, an alkyl group, an alkoxy group, an oxycarbonyl group, an alkoxycarbonyl group, a (poly)alkyleneoxy group, or an alkylthio group is preferable, and an alkyl group, an alkoxy group, or a (poly)alkyleneoxy group is more preferable.

In addition, from the viewpoint of exhibiting the liquid crystal properties of the high-molecular-weight compound or adjusting the phase transition temperature and the viewpoint of solubility, the number of carbon atoms in the alkyl group other than a hydrogen atom, a halogen atom, and a cyano group among the groups represented by B is preferably 1 to 20 and more preferably 1 to 11.

A case where B in Formula (6) represents a crosslinking group will be described.

Examples of the crosslinking group include a polymerizable group described in paragraphs “0040” to “0050” of JP2010-244038A. In particular, from the viewpoints of reactivity and synthesis suitability, an acryloyl group, a methacryloyl group, an epoxy group, an oxetanyl group, or a styryl group is preferable, and an acryloyl group or a methacryloyl group (hereinafter, also abbreviated as “(meth)acryloyl group”) is more preferable.

In the present invention, from the viewpoint of further improving the dichroic ratio of the optically-anisotropic layer, a liquid crystal polymer can be used as the high-molecular-weight compound.

Here, liquid crystal properties may be either nematic properties or smectic properties and preferably at least nematic properties.

A temperature range where a nematic phase is exhibited is preferably room temperature (23° C.) to 300° C. and more preferably 50° C. to 200° C. from the viewpoints of handleability and manufacturing suitability.

Further, in the present invention, the weight-average molecular weight (Mw) of the high-molecular-weight compound is preferably 1000 to 100000 and more preferably 2000 to 60000. In addition, the number-average molecular weight (Mn) is preferably 500 to 80000 and more preferably 1000 to 30000.

Here, in the present invention, the number-average molecular weight and the weight-average molecular weight are values measured by gel permeation chromatography (GPC).
Solvent (Eluent): tetrahydrofuran
Device name: TOSOH HLC-8220 GPC
Column: Three TOSOH TSKgel Super HZM-H's (4.6 mm×15 cm) connected together
Column temperature: 25° C.
Sample concentration: 0.1 mass %
Flow rate: 0.35 ml/min
Calibration curve: a calibration curve obtained using seven samples of TSK standard polystyrene (manufactured by TOSOH Corporation) at Mw=2800000 to 1050 (Mw/Mn=1.03 to 1.06)

In the present invention, the maximum absorption wavelength of the high-molecular-weight compound is preferably 380 nm or shorter from the viewpoint that the absorption in a visible range is low and the alignment of the dichromatic colorant compound in a visible range can be easily maintained.

In a case where an azo group is included as a linking group in M, the absorption in a visible range is high, which is not preferable.

In addition, in the present invention, from the viewpoint of further improving the dichroic ratio of the optically-anisotropic layer, it is preferable that the number of benzene ring in the mesogen group of the high-molecular-weight compound is 3 or more.

Among high-molecular-weight compounds in the composition according to the embodiment of the present invention, specific examples of the high-molecular-weight compound having a repeating unit represented by Formula (6) include high-molecular-weight compounds represented by the following structural formulae. In the structural formulae, R represents a hydrogen atom or a methyl group.

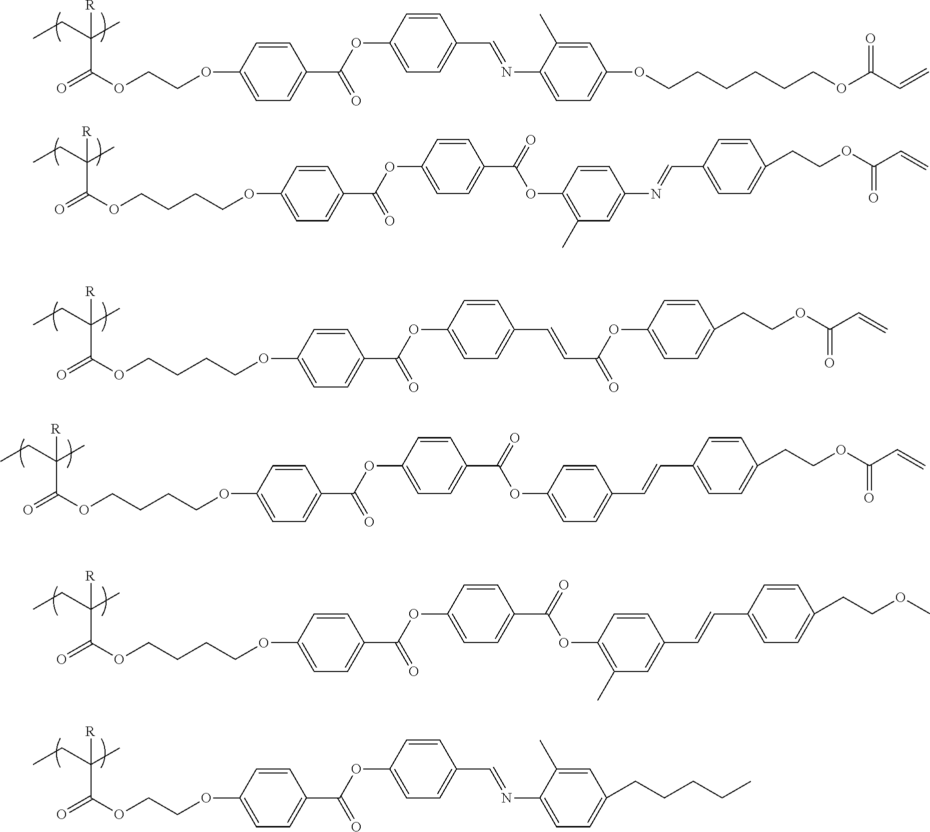

In the present invention, as the high-molecular-weight liquid crystal compound, a high-molecular-weight liquid crystal compound including a repeating unit represented by Formula (7) described below is more preferable. In Formula (7) described below, a difference between a log P value of P1 (hereinafter, also referred to as “main chain”), L1, and SP1 (hereinafter, also referred to as “spacer group”) and a log P value of M1 (hereinafter, also referred to as “mesogen group”) is 4 or more.

By using the above-described high-molecular-weight liquid crystal compound, an optically-anisotropic layer having a high alignment degree can be formed. The detailed reason for this is not clear but is presumed to be as follows.

The log P value is an index representing hydrophilicity and hydrophobicity of a chemical structure. In the repeating unit represented by Formula (7) described below, the log P value of the main chain, L1, and the spacer group and the log P value of the mesogen group are spaced from each other by a predetermined value or more. Therefore, compatibility between the structure from the main chain to the spacer group and the mesogen group is low. As a result, it is presumed that the crystallinity of the high-molecular-weight liquid crystal compound increases such that the alignment degree of the high-molecular-weight liquid crystal compound is high. This way, it is presumed that, in a case where the alignment degree of the high-molecular-weight liquid crystal compound is high, the compatibility between high-molecular-weight liquid crystal compound and the dichroic colorant decreases (that is, the crystallinity of the dichroic colorant is improved), and the alignment degree of the dichroic colorant is improved. As a result, it is presumed that the alignment degree of the obtained optically-anisotropic layer is improved.

The preferable high-molecular-weight liquid crystal compound in the present invention includes a repeating unit represented by the following Formula (7) (in the present specification, also referred to as “repeating unit (7)”). In addition, in the repeating unit (7), a difference between a log P value of P1, L1, and SP1 and a log P value of M1 is 4 or more.

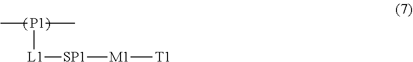

In Formula (7), P1 represents a main chain in the repeating unit, L1 represents a single bond or a divalent linking group, SP1 represents a spacer group, M1 represents a mesogen group, and T1 represents a terminal group.

In a case where M1 represents a linking group, an azo group is not included as the linking group.

Specific examples of the main chain of the repeating unit represented by P1 include groups represented by the following Formulae (P1-A) to (P1-D). In particular, the group represented by the following Formula (P1-A) is preferable from the viewpoint of diversity of monomers as raw materials and handleability.

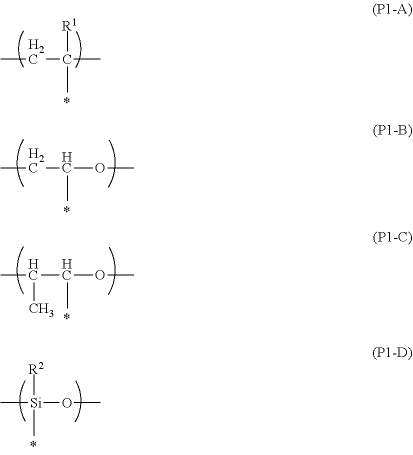

In Formulae (P1-A) to (P1-D), “*” represents a binding site to L1 in Formula (7). In Formula (P1-A), R¹ represents a hydrogen atom or a methyl group. In Formula (P1-D), R² represents an alkyl group.

It is preferable that the group represented by Formula (P1-A) is one unit in a partial structure of a poly(meth)acrylic acid ester obtained by polymerization of a (meth)acrylic acid ester.

It is preferable that the group represented by Formula (P1-B) is an ethylene glycol unit in polyethylene glycol obtained by polymerization of ethylene glycol.

It is preferable that the group represented by Formula (P1-C) is a propylene glycol unit obtained by polymerization of propylene glycol.

It is preferable that the group represented by Formula (P1-D) is a siloxane unit in polysiloxane obtained by polycondensation of silanol. Here, silanol is a compound represented by Formula Si(R²)₃(OH). In the formula, a plurality of R²'s each independently represent a hydrogen atom or an alkyl group. In this case, at least one of a plurality of R²'s represents an alkyl group.

L1 represents a single bond or a divalent linking group.

Examples of the divalent linking group represented by L1 include —C(O)O—, —OC(O)—, —O—, —S—, —C(O)NR³—, —NR³C(O)—, —SO₂—, and —NR³R⁴—. In the formula, R³ and R⁴ each independently represent a hydrogen atom or an alkyl group having 1 to 6 carbon atoms which may have a substituent.

In a case where P1 represents the group represented by Formula (P1-A), it is preferable that L1 represents a group represented by —C(O)O—.

In a case where P1 represents the group represented by any one of Formulae (P1-B) to (P1-D), it is preferable that L1 represents a single bond.

From the viewpoint that liquid crystal properties can be easily exhibited or raw material availability can be achieved, it is preferable that the spacer group represented by SP1 includes at least one structure selected from the group consisting of an oxyethylene structure, an oxypropylene structure, a polysiloxane structure, and a fluorinated alkylene structure.

Here, it is preferable that the oxyethylene structure represented by SP1 is a group represented by *—(CH₂—CH₂O)ₙ₁—*. In the formula, n1 represents an integer of 1 to 20, and * represents a binding site to L1 or M1.

In addition, it is preferable that the oxypropylene structure represented by SP1 is a group represented by *—(CH(CH₃)—CH₂O)ₙ₂—*. In the formula, n2 represents an integer of 1 to 3, and * represents a binding site to L1 or M1.

In addition, it is preferable that the polysiloxane structure represented by SP1 is a group represented by *—(Si(CH₃)₂—O)ₙ₃—*. In the formula, n3 represents an integer of 6 to 10, and * represents a binding site to L1 or M1.

In addition, it is preferable that the fluorinated alkylene structure represented by SP1 is a group represented by *—(CF₂—CF₂)ₙ₄—*. In the formula, n4 represents an integer of 6 to 10, and * represents a binding site to L1 or M1.

The mesogen group represented by M1 is a group representing a main skeleton of liquid crystal molecules contributing to liquid crystal formation. The liquid crystal molecules exhibit liquid crystal properties in an intermediate state (mesophase) between a liquid crystal state and an isotropic liquid state. The mesogen group is not particularly limited, and the details can be found in, for example, in particular, pp. 7 to 16 of “Flussige Kristalle in Tabellen II” (VEB Deutscher Verlag fur Grundstoffindustrie, Leipzig, 1984) and in particular, Chapter 3 of Liquid crystal Handbook (Maruzen, 2000) edited by Liquid Crystal Handbook Editing Committee.

As the mesogen group, for example, a group having at least one cyclic structure selected from the group consisting of an aromatic hydrocarbon group, a heterocyclic group, and an alicyclic group is preferable.

From the viewpoints of exhibiting liquid crystal properties, adjusting the liquid crystal phase transition temperature, and achieving raw material availability and synthesis suitability, a group represented by the following Formula (M1-A) or Formula (M1-B) is preferable as the mesogen group.

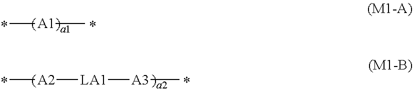

In Formula (M1-A), A1 represents a divalent group selected from the group consisting of an aromatic hydrocarbon group, a heterocyclic group, and an alicyclic group. These groups may be substituted with a substituent such as an alkyl group, a fluorinated alkyl group, or an alkoxy group.

It is preferable that the divalent group represented by A1 is a 4-membered to 6-membered ring. In addition, the divalent group represented by A1 may be a monocycle or a fused ring.

* represents a binding site to SP1 or T1.

Examples of the divalent aromatic hydrocarbon group represented by A1 include a phenylene group, a naphthylene group, a fluorene-diyl group, an anthracene-diyl group, and a tetracene-diyl group. From the viewpoints of the diversity of design of the mesogen skeleton and raw material availability, a phenylene group or a naphthylene group is preferable, and a phenylene group is more preferable.

The divalent heterocyclic group represented by A1 may be aromatic or nonaromatic. From the viewpoint of further improving the alignment degree, a divalent aromatic heterocyclic group is preferable.

Examples of an atom other than carbon forming the divalent aromatic heterocyclic group include a nitrogen atom, a sulfur atom, and an oxygen atom. In a case where the aromatic heterocyclic group has a plurality of atoms forming the ring other than carbon, the atoms may be the same as or different from each other.

Specific examples of the divalent aromatic heterocyclic group include a pyridylene group (pyridine-diyl group), a pyridazine-diyl group, an imidazole-diyl group, a thienylene (thiophene-diyl group), a quinolinene group (quinoline-diyl group), an isoquinolylene group (isoquinoline-diyl group), an oxazole-diyl group, a thiazole-diyl group, an oxadiazole-diyl group, a benzothiazole-diyl group, a benzothiadiazolediyl group, a phthalimide-diyl group, a thienothiazole-diyl group, a thiazolothiazole-diyl group, a thienothiophene-diyl group, and a thienooxazole-diyl group.

Specific examples of the divalent alicyclic group represented by A1 include a cyclopentylene group and a cyclohexylene group.

In Formula (M1-A), a1 represents an integer of 1 to 10. In a case where a1 represents 2 or more, a plurality of A1's may be the same as or different from each other.

In Formula (M1-B), A2 and A3 each independently represent a divalent group selected from the group consisting of an aromatic hydrocarbon group, a heterocyclic group, and an alicyclic group. Since specific examples and preferable aspects of A2 and A3 are the same as those of A1 in Formula (M1-A), the description thereof will not be repeated.

In Formula (M1-B), a2 represents an integer of 1 to 10, and in a case where a2 represents 2 or more, a plurality of A2's may be the same as or different from each other, a plurality of A3's may be the same as or different from each other, and a plurality of LA1's may be the same as or different from each other.

In Formula (M1-B), in a case where a2 represents 1, LA1 represents a divalent linking group. In a case where a2 represents 2 or more, a plurality of LA1's each independently represent a single bond or a divalent linking group, and at least one of a plurality of LA1's represents a divalent linking group.

Examples of the divalent linking group represented by LA1 in Formula (M1-B) include —O—, —(CH₂)_{g}—, —(CF₂)_{g}—, —Si(CH₃)₂—, —(Si(CH₃)₂O)_{g}—, —(OSi(CH₃)₂)_{g}— (g represents an integer of 1 to 10), —N(Z)—, —C(Z)═C(Z′)—, —C(Z)═N—, —N═C(Z)—, —C(Z)₂—C(Z′)₂—, —C(O)—, —OC(O)—, —C(O)O—, —O—C(O)O—, —N(Z)C(O)—, —C(O)N(Z)—, —C(Z)═C(Z′)—C(O)O—, —O—C(O)—C(Z)═C(Z′)—, —C(Z)═N—, —N═C(Z)—, —C(Z)═C(Z′)—C(O)N(Z″)—, —N(Z″)—C(O)—C(Z)═C(Z′)—, —C(Z)═C(Z′)—C(O)—S—, —S—C(O)—C(Z)—C(Z′)— (Z, Z′, and Z″ each independently represent a hydrogen atom, C1 to C4 alkyl group, a cycloalkyl group, an aryl group, a cyano group, or a halogen atom), —C≡C—, —S—, —S(O)—, —S(O)(O)—, —(O)S(O)O—, —O(O)S(O)O—, —SC(O)—, and —C(O)S—. LA1 may represent a group including a combination of two or more of the above-described groups.

In a case where an azo group is included as the divalent linking group represented by LA1, the absorption in a visible range is high, which is not preferable.

Specific examples of M1 include the following structures. In the following specific examples, “Ac” represents an acetyl group.

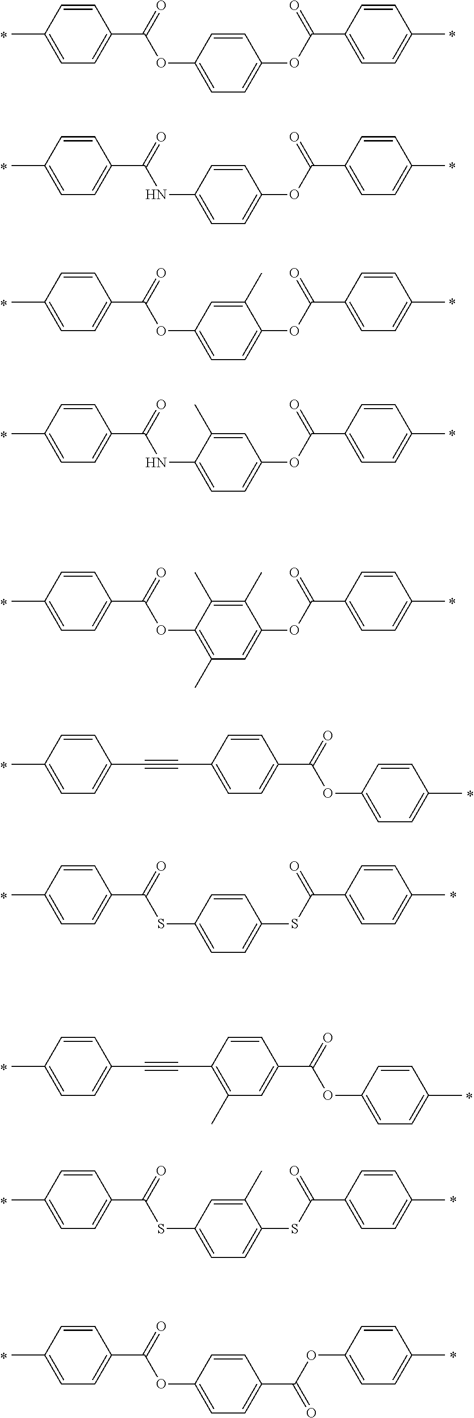

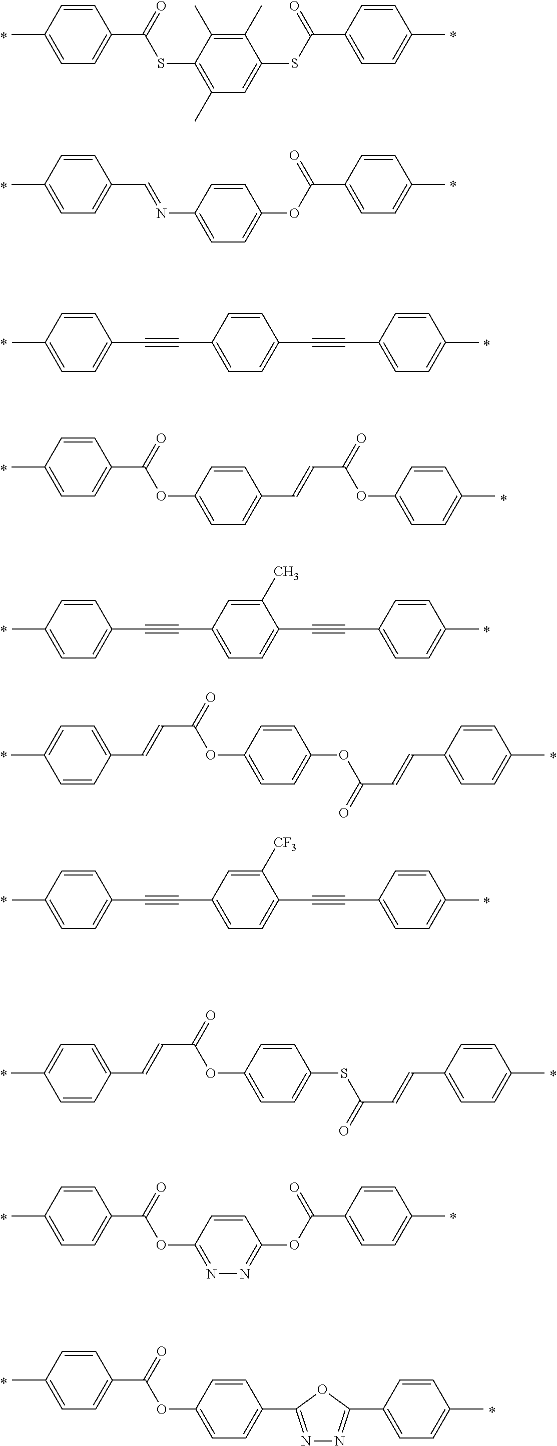

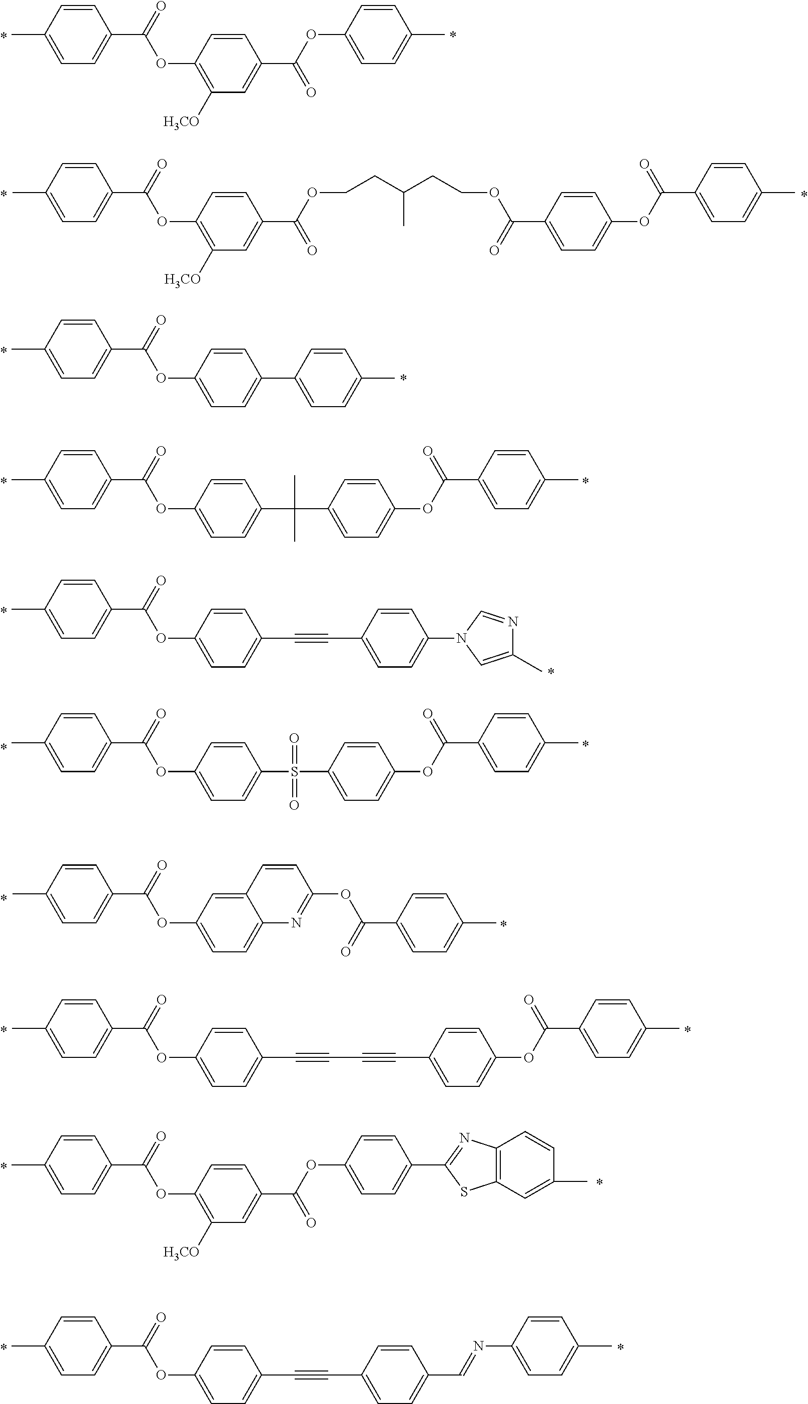

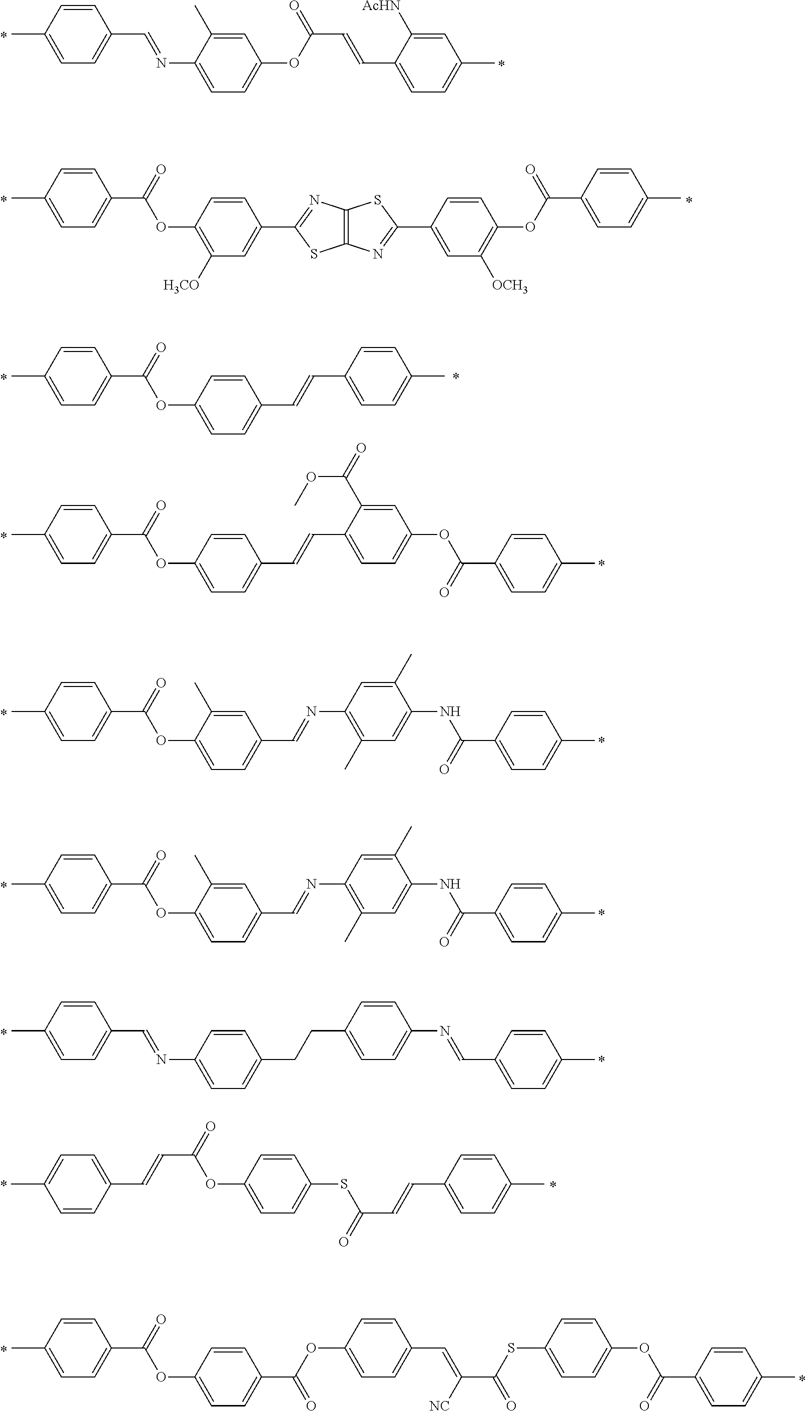

Examples of the terminal group represented by T1 include a hydrogen atom, a halogen atom, a cyano group, a nitro group, a hydroxy group, an alkyl group having 1 to 10 carbon atoms, an alkoxy group having 1 to 10 carbon atoms, an alkylthio group having 1 to 10 carbon atoms, an oxycarbonyl group having 1 to 10 carbon atoms, an acyloxy group having 1 to 10 carbon atoms, an acylamino group having 1 to 10 carbon atoms, an alkoxycarbonyl group having 1 to 10 carbon atoms, an alkoxycarbonylamino group having 1 to 10 carbon atoms, a sulfonylamino group having 1 to 10 carbon atoms, a sulfamoyl group having 1 to 10 carbon atoms, a carbamoyl group having 1 to 10 carbon atoms, a sulfinyl group having 1 to 10 carbon atoms, and an ureido group having 1 to 10 carbon atoms. These terminal groups may be further substituted with the groups or a polymerizable group described in JP2010-244038A.

The number of atoms in the main chain of T1 is preferably 1 to 20, more preferably 1 to 15, still more preferably 1 to 10, and still more preferably 1 to 7. By setting the number of atoms in the main chain of T1 to be 20 or less, there is an advantageous effect in that the alignment degree of the optically-anisotropic layer is further improved. Here, “main chain” in T1 refers to the longest molecular chain bonded to M1, and the number of hydrogen atoms is not included in the number of atoms in the main chain of T1. For example, in a case where T1 represents a n-butyl group, the number of atoms in the main chain is 4. In a case where T1 represents a sec-butyl group, the number of atoms in the main chain is 3.

The content of the repeating unit (7) is preferably 20% to 100 mass %, more preferably 30% to 99.9 mass %, and still more preferably 40% to 99.0 mass % with respect to 100 mass % of all the repeating units in the high-molecular-weight liquid crystal compound.

In the present invention, the content of each of the repeating units in the high-molecular-weight liquid crystal compound is calculated based on the amount (mass) of each of the monomers used for obtaining each of the repeating units.

As the repeating unit (7), the high-molecular-weight liquid crystal compound may include one kind alone or two or more kinds. In a case where the high-molecular-weight liquid crystal compound includes two or more repeating units (7), there are advantageous effects in that, for example, the solubility of the high-molecular-weight liquid crystal compound in a solvent is improved and the liquid crystal phase transition temperature can be easily adjusted. In a case where the high-molecular-weight liquid crystal compound includes two or more repeating units (7), it is preferable that the total content thereof is in the above-described range.

In a case where the high-molecular-weight liquid crystal compound includes two or more repeating units (7), a repeating unit (7) not having a polymerizable group in T1 and a repeating unit (7) having a polymerizable group in T1 may be used in combination. As a result, the curing properties of the optically-anisotropic layer are further improved.

In this case, in the high-molecular-weight liquid crystal compound, a ratio of the mass of the repeating unit (7) having a polymerizable group in T1 to the mass of the repeating unit (7) not having a polymerizable group in T1 (the repeating unit (7) having a polymerizable group in T1/the repeating unit (7) not having a polymerizable group in T1) is preferably 0.005 to 4 and more preferably 0.01 to 2.4. In a case where the mass ratio is 4 or lower, there is an advantageous effect in that the alignment degree is high. In a case where the mass ratio is 0.05 or higher, the curing properties of the optically-anisotropic layer are further improved.

(Log P Value)

In Formula (7), a difference (log P₁−log P₂) between a log P value of P1, L1, and SP1 (hereinafter, also referred to as “log P₁”) and a log P value of M1 (hereinafter, also referred to as “log P₂”) is 4 or more, preferably 4.25 or more, and more preferably 4.5 or more from the viewpoint of further improving the alignment degree of the optically-anisotropic layer.

In addition, from the viewpoints adjusting the liquid crystal phase transition temperature and achieving synthesis suitability, the upper limit value of the difference is preferably 15 or less, more preferably 12 or less, and still more preferably 10 or less.

Here, the log P value is an index representing hydrophilicity and hydrophobicity of a chemical structure, and is also called a hydrophilicity/hydrophobicity parameter. The log P value can be calculated using software such as ChemBioDraw Ultra or HSPiP (Ver. 4.1.07). In addition, the log P value can be experimentally obtained using a method described in OECD Guidelines for the Testing of Chemicals, Sections 1, Test No. 117. In the present invention, unless specified otherwise, a value calculated by inputting a structural formula of a compound into HSPiP (Ver. 4.1.07) is adopted as the log P value.

The log P₁ refers to the log P value of P1, L1, and SP1 as described above. “The log P value of P1, L1, and SP1” refers to a log P value of an integrated structure of P1, L1, and SP1 and is not the sum of respective log P values of P1, L1, and SP1. Specifically, the log P₁ can be calculated by inputting a series of structural formulae of P1 to SP1 in Formula (7) into the software.

In order to calculate log P₁, regarding the portion of the group represented by P1 among the series of structural formulae P1 to SP1, the structure of the group represented by P1 (for example, Formulae (P1-A) to (P1-D) may be used as it is, or a structure of a group which may form P1 after polymerization of a monomer used to obtain the repeating unit represented by Formula (7) may be used.

Here, specific examples of the latter case (the group which may form P1) are as follows. In a case where P1 is obtained by polymerization of (meth)acrylic acid ester, a group represented by CH₂═C(R¹)— (R¹ represents a hydrogen atom or a methyl group) can be used. In addition, in a case where P1 is obtained by polymerization of ethylene glycol, ethylene glycol can be used. In a case where P1 is obtained by polymerization of propylene glycol, propylene glycol can be used. In addition, in a case where P1 is obtained by polycondensation of silanol, silanol (a compound represented by Formula Si(R²)₃(OH); a plurality of R²'s each independently represent a hydrogen atom or an alkyl group, and at least one of a plurality of R²'s represents an alkyl group) can be used.

In a case where the difference between log P₁ and Log P₂ is 4 or more, log P₁ may be lower than or may be higher than Log P₂.

Here, the log P value (the above-described log P₂) of the general mesogen group tends to be in a range of 4 to 6. At this time, in a case where log P₁ is lower than log P₂, the value of log P₁ is preferably 1 or less and more preferably 0 or less. On the other hand, in a case where log P₁ is higher than log P₂, the value of log P₁ is preferably 8 or more and more preferably 9 or more.

In a case where P1 in Formula (7) is obtained by polymerization of (meth)acrylic acid ester and log P₁ is lower than log P₂, the log P value of SP1 in Formula (7) is preferably 0.7 or less and more preferably 0.5 or less. On the other hand, in a case where P1 in Formula (7) is obtained by polymerization of (meth)acrylic acid ester and log P₁ is higher than log P₂, the log P value of SP1 in Formula (7) is preferably 3.7 or more and more preferably 4.2 or more.

Examples of a structure having a log P value of 1 or less include an oxyethylene structure and an oxypropylene structure. Examples of a structure having a log P value of 6 or more include a polysiloxane structure and a fluorinated alkylene structure.

The weight-average molecular weight (Mw) of the high-molecular-weight liquid crystal compound is preferably 1000 to 500000, more preferably 3000 to 100000, and still more preferably 5000 to 50000. In a case where Mw of the high-molecular-weight liquid crystal compound is in the above-described range, the high-molecular-weight liquid crystal compound can be easily handled.

In particular, from the viewpoint of suppressing cracking during application, the weight-average molecular weight (Mw) of the high-molecular-weight liquid crystal compound is preferably 10000 or higher and more preferably 10000 to 100000.

In addition, from the viewpoint of the temperature latitude of the alignment degree, the weight-average molecular weight (Mw) of the high-molecular-weight liquid crystal compound is preferably lower than 50000 and more preferably 3000 or higher and lower than 50000.

Here, in the present invention, the number-average molecular weight and the weight-average molecular weight are values measured by gel permeation chromatography (GPC) as described above.

Here, the liquid crystal properties of the high-molecular-weight liquid crystal compound may be either nematic properties or smectic properties and preferably at least nematic properties.

A temperature range where a nematic phase is exhibited is preferably room temperature (23° C.) to 450° C. and more preferably 50° C. to 400° C. from the viewpoints of handleability and manufacturing suitability.

<Interface Improver>

It is preferable that the optically-anisotropic layer-forming composition includes an interface improver. By the optically-anisotropic layer-forming composition including an interface improver, the smoothness of the coating surface is improved, the alignment degree is improved, cissing and unevenness is suppressed, and improvement of in-plane uniformity is expected.

As the interface improver, a compound described in paragraphs “0253” to “0293” of JP2011-237513A can be used.

In a case where the composition includes an interface improver, the content of the interface improver is preferably 0.001 to 5 parts by mass and more preferably 0.01 to 3 parts by mass with respect to 100 parts by mass of the total content of the dichroic colorant and the liquid crystal compound in the optically-anisotropic layer-forming composition.

<Polymerization Initiator>

The optically-anisotropic layer-forming composition may include a polymerization initiator.

The polymerization initiator is not particularly limited and is preferably a compound having photosensitivity, that is, a photopolymerization initiator.

As the photopolymerization initiator, various compounds can be used without any particular limitation. Examples of the photopolymerization initiator include an α-carbonyl compound (described in U.S. Pat. Nos. 2,367,661A and 2,367,670A), an acyloin ether (described in U.S. Pat. No. 2,448,828A), an α-hydrocarbon-substituted aromatic acyloin compound (described in U.S. Pat. No. 2,722,512A), a polynuclear quinone compound (described in U.S. Pat. Nos. 3,046,127A and 2,951,758A), a combination of a triaryl imidazole dimer and p-aminophenyl ketone (described in U.S. Pat. No. 3,549,367A), an acridine compound and a phenazine compound (described in JP1985-105667A (JP-S60-105667A) and U.S. Pat. No. 4,239,850A), an oxadiazole compound (described in U.S. Pat. No. 4,212,970A), and an acylphosphine oxide compound (described in JP1988-040799B (JP-S63-040799B), JP1993-029234B (JP-H5-029234B), JP1998-095788A (JP-H10-095788A), andJP1998-029997A (JP-H10-029997A)).

As the photopolymerization initiator, a commercially available product can be used, and examples thereof include IRGACURE 184, IRGACURE 907, IRGACURE 369, IRGACURE 651, IRGACURE 819, and IRGACURE OXE-01 manufactured by BASF SE.

In a case where the composition according to the embodiment of the present invention includes a polymerization initiator, the content of the polymerization initiator is preferably 0.01 to 30 parts by mass and more preferably 0.1 to 15 parts by mass with respect to 100 parts by mass of the total content of the dichroic colorant and the liquid crystal compound in the composition. By adjusting the content of the polymerization initiator to be 0.01 parts by mass or more, the curing properties of the optically-anisotropic layer are improved. By adjusting the content of the polymerization initiator to be 30 parts by mass or less, the alignment of the optically-anisotropic layer is improved.

<Solvent>

It is preferable that the optically-anisotropic layer-forming composition includes a solvent from the viewpoint of workability or the like.

Examples of the solvent include an organic solvent such as a ketone, an ether, an aliphatic hydrocarbon, an alicyclic hydrocarbon, an aromatic hydrocarbon, a halogenated carbon, an ester, an alcohol, a cellosolve, a cellosolve acetate, a sulfoxide, an amide, or a heterocyclic compound, and water.

Specifically, examples of the ketone include acetone, 2-butanone, methyl isobutyl ketone, cyclopentanone, and cyclohexanone. Examples of the ether include dioxane and tetrahydrofuran. Examples of the aliphatic hydrocarbon include hexane. Examples of the alicyclic hydrocarbon include cyclohexane. Examples of the aromatic hydrocarbon include benzene, toluene, xylene, and trimethylbenzene. Examples of the halogenated carbon include dichloromethane, trichloromethane, dichloroethane, dichlorobenzene, and chlorotoluene. Examples of the ester include methyl acetate, ethyl acetate, and butyl acetate. Examples of the alcohol include ethanol, isopropanol, butanol, and cyclohexanol. Examples of the cellosolve include methyl cellosolve, ethyl cellosolve, and 1,2-dimethoxyethane. Examples of the cellosolve acetate and the sulfoxide include dimethyl sulfoxide. Examples of the amide include dimethylformamide and dimethylacetamide. Further, examples of the heterocyclic compound include pyridine.

Among these solvents, one kind may be used alone, or two or more kinds may be used in combination.

Among these solvents, an organic solvent is preferable, and a halogenated carbon or a ketone is more preferable.

In a case where the composition includes the solvent, the content of the solvent is preferably 80% to 99 mass %, more preferably 83% to 97 mass %, and still more preferably 85% to 95 mass % with respect to the total mass of the composition.

<Other Components>

The optically-anisotropic layer-forming composition may further include a dichroic colorant other than the specific dichroic colorant or may include a plurality of specific dichroic colorants. In a case where the composition includes a plurality of dichroic colorants, from the viewpoint of further curing the composition, it is preferable that the composition includes a dichroic colorant having a crosslinking group which is crosslinked with the specific dichroic colorant, and it is more preferable that the composition includes a plurality of specific dichroic colorants.

Hereinafter, a compound represented by Formula (1) as another component that may be included in the optically-anisotropic layer-forming composition will be described.

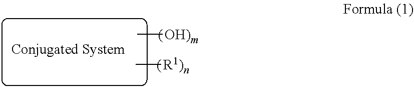

(In Formula (1), a conjugated system is a collective term for the following aromatic hydrocarbons and represents a monocyclic structure such as benzene, a fused ring structure including 1 to 3 benzene rings such as naphthalene or anthracene, or a polycyclic structure including 1 to 3 benzene rings such as biphenyl or terphenyl. R¹'s each independently represent any one selected from an alkyl group, an alkenyl group, an alkynyl group, an aryl group, a monovalent heterocyclic group, or a silyl group. m represents an integer of 1 to 3, and n represents an integer of 1 to 6.)

—OH represents a hydroxyl group is linked to the conjugated system.

m represents an integer of 1 to 5, preferably 1 to 3, and more preferably 1.

In Formula (1), a conjugated system is a collective term for the following aromatic hydrocarbons and represents a monocyclic structure such as benzene, a fused ring structure including 1 to 3 benzene rings such as naphthalene or anthracene, or a polycyclic structure including 1 to 3 benzene rings such as biphenyl or terphenyl, preferably a monocycle, a fused ring, or a polycyclic structure including 1 or 2 benzene rings, and more preferably a benzene ring monocyclic structure.

In the formula, R¹'s each independently represent any one selected from an alkyl group, an alkenyl group, an alkynyl group, an aryl group, a monovalent heterocyclic group, or a silyl group.

As the alkyl group represented by R¹, an alkyl group having 1 to 15 carbon atoms is preferable, an alkyl group having 1 to 10 carbon atoms is more preferable, and an alkyl group having 1 to 5 carbon atoms is still more preferable. The alkyl group may be linear, branched, or cyclic and may further have a substituent. Specific examples of the alkyl group include a methyl group, an ethyl group, an n-propyl group, an isopropyl group, a t-butyl group, an n-octyl group, an eicosyl group, a 2-ethylhexyl group, a cyclohexyl group, a cyclopentyl group, a 4-n-dodecylcyclohexyl group, a bicyclo[1,2,2]heptane-2-yl group, and a bicyclo[2,2,2]octan-3-yl group. Among these, a methyl group, an ethyl group, an n-propyl group, an isopropyl group, or a t-butyl group is preferable.

As the alkenyl group represented by R¹, an alkenyl group having 2 to 15 carbon atoms is preferable, an alkenyl group having 2 to 10 carbon atoms is more preferable, and an alkenyl group having 2 to 5 carbon atoms is still more preferable. The alkenyl group may be linear, branched, or cyclic and may further have a substituent. Specific examples of the alkenyl group include a vinyl group, a 1-propenyl group, a 1-butenyl group, a 1-methyl-1-propenyl group, a 1-cyclopentenyl group, and a 1-cyclohexenyl group. Among these, a vinyl group, a 1-propenyl group, or a 1-butenyl group is preferable.

As the alkynyl group represented by R¹, an alkynyl group having 2 to 15 carbon atoms is preferable, an alkynyl group having 2 to 10 carbon atoms is more preferable, and an alkynyl group having 2 to 5 carbon atoms is still more preferable. The alkynyl group may be linear, branched, or cyclic and may further have a substituent. Specific examples of the alkynyl group include an ethynyl group, a 1-propynyl group, a 1-butynyl group, and a 1-octynyl group. Among these, an ethynyl group, a 1-propynyl group, or a 1-butynyl group is preferable.

As the aryl group represented by R¹, an aryl group having 6 to 18 carbon atoms is preferable, an aryl group having 6 to 14 carbon atoms is more preferable, and an aryl group having 6 to 10 carbon atoms is still more preferable. Specific examples of the aryl group include a phenyl group, a naphthyl group, an anthranil group, and a pyrenyl group. Among these, a phenyl group or a naphthyl group is preferable.

As the monovalent heterocyclic group represented by R¹, a heterocyclic group having 1 to 10 carbon atoms is preferable, a heterocyclic group having 2 to 7 carbon atoms is more preferable, and a 5- or 6-membered heterocyclic group is still more preferable. The heterocyclic group may be a fused ring and may have a structure in which an aromatic ring and a hetero ring are fused. Specific examples of the heterocyclic group include a 4-pyridyl group, a 2-furyl group, a 2-thienyl group, a 2-pyrimidinyl group, and a 2-benzothiazolyl group. Among these, a 4-pyridyl group or a 2-furyl group is preferable. As the heteroatom, a nitrogen atom, a sulfur atom, or an oxygen atom is preferable, and a sulfur atom is more preferable.

As the silyl group represented by R¹, a silyl group having 3 to 15 carbon atoms is preferable, a silyl group having 3 to 10 carbon atoms is more preferable, and a silyl group having 3 to 6 carbon atoms is still more preferable. Specific examples of the silyl group include a trimethylsilyl group, a t-butyldimethylsilyl group, and a phenyldimethylsilyl group. Among these, a trimethylsilyl group is preferable.

Among the alkyl group, the alkenyl group, the alkynyl group, the aryl group, the heterocyclic group, and the silyl group, a group having a hydrogen atom may be substituted with the following substituent after removing the hydrogen atom. Examples of the substituent include a halogen atom, an alkyl group, an alkenyl group, an alkynyl group, an aryl group, a heterocyclic group, a hydroxyl group, a nitro group, a carboxyl group, an alkoxy group, an aryloxy group, a silyloxy group, a heterocyclic oxy group, an acyloxy group, a carbamoyloxy group, an alkoxycarbonyloxy group, an aryloxycarbonyloxy group, an oxyalkylene group, an amino group, an acylamino group, an aminocarbonylamino group, an alkoxycarbonylamino group, an aryloxycarbonylamino group, a sulfamoylamino group, an alkyl or arylsulfonylamino group, a mercapto group, an alkylthio group, an arylthio group, a heterocyclic thio group, a sulfamoyl group, a sulfo group, an alkyl- or aryl-sulfinyl group, an alkyl or arylsulfonyl group, an acyl group, an aryloxycarbonyl group, an alkoxycarbonyl group, a carbamoyl group, an aryl or heterocyclic azo group, an imido group, a phosphino group, a phosphinyl group, a phosphinyloxy group, a phosphinylamino group, and a silyl group. In the above-described examples, the alkyl group includes a cycloalkyl group and a bicycloalkyl group. In addition, the alkenyl group includes a cycloalkenyl group and a bicycloalkenyl group. Further, the amino group includes an anilino group.

Two or more substituents may be included, or one or more substituents may be included.

In Formula (I), it is more preferable that R¹ represents an alkyl group.

n represents an integer of 1 to 6, preferably 2 to 4, and more preferably 3.

In a case where n represents 2 or more, a plurality of R¹'s may be the same as or different from each other. R¹'s may form a ring.

Hereinafter, specific compound examples will be shown, but the present invention is not limited to the following structures.

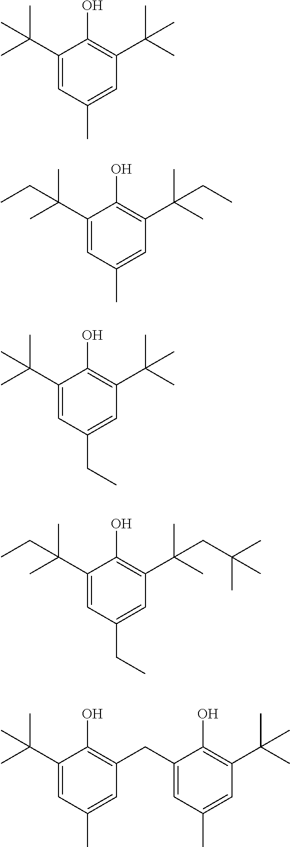

The content or the compound represented by Formula (1) is preferably 1% to 500 mol %, more preferably 2 mol % to 200 mol %, and still more preferably 2 mol % to 50 mol % as a molar ratio to the dichroic colorant.

<Forming Method>

A method of forming the optically-anisotropic layer using the optically-anisotropic layer-forming composition including the liquid crystal compound and the dichroic colorant is not particularly limited.

For example, the method includes: a step (hereinafter, also referred to as “coating film forming step”) of applying the optically-anisotropic layer-forming composition to a transparent support to form a coating film; a step (hereinafter, also referred to as “alignment step”) of aligning a liquid crystal component in the coating film in this order.

In the following description, “optically-anisotropic layer-forming composition” will also be simply referred to as “composition”.

In a case where the dichroic colorant is liquid crystalline, the liquid crystal component also includes the dichroic colorant having liquid crystal properties in addition to the above-described liquid crystal compound.

(Coating Film Forming Step)

In the coating film forming step, the composition is applied to a transparent support to form a coating film.

The composition can be easily applied to the transparent support by using a composition including the above-described solvent or by heating the composition to obtain a liquid such as a melt.

Specific examples of the composition include a well-known method such as a roll coating method, a gravure printing method, a spin coating method, a wire bar coating method, an extrusion coating method, a direct gravure coating method, a reverse gravure coating method, a die coating method, a spray coating method, or an ink jet method.

In this aspect, the example where the composition is applied to the transparent support is shown, but the present invention is not limited thereto. For example, as described above, as shown in FIG. 6, the optical element according to the embodiment of the present invention includes the alignment film 13 on the support 12; and the optically-anisotropic layer 14 on the alignment film 13. In this case, the composition is applied to the alignment layer 13 provided on the support 12. The details of the alignment layer 13 will be described below.

(Alignment Step)

In the alignment step, the liquid crystal component in the coating film (composition) is aligned. As a result, the optically-anisotropic layer is obtained.

The alignment step may include a drying treatment. Through the drying treatment, a component such as the solvent may be removed from the coating film. The drying treatment may be performed using a method (for example, natural drying) of leaving the coating film to stand at room temperature for a predetermined time, or may be performed a method of performing heating and/or blowing.

Here, the liquid crystal component in the composition may be aligned through the coating film forming step or the drying treatment. For example, in an aspect where the composition is prepared as a coating solution including the solvent, by drying the coating film to remove the solvent from the coating film, a coating film (that is, the optically-anisotropic layer) having light absorption anisotropy can be obtained.

In a case where the drying treatment is performed at a temperature higher than or equal to a temperature of transition of the liquid crystal component in the coating film into a liquid crystal phase, a heating treatment described below is not necessarily performed.

The temperature of transition of the liquid crystal component in the coating film into a liquid crystal phase is preferably 10° C. to 250° C. and more preferably 25° C. to 190° C. from the viewpoints of manufacturing suitability and the like.

In a case where the temperature of transition of the liquid crystal component in the coating film into a liquid crystal phase is 10° C. or higher, a cooling treatment for decreasing the temperature up to the temperature range where a liquid crystal phase is exhibited is not required, which is not preferable. In addition, in a case where the temperature of transition of the liquid crystal component in the coating film into a liquid crystal phase is 250° C. or lower, a high temperature is not required in order to obtain an isotropic liquid state at a temperature higher than the temperature range where a liquid crystal phase is exhibited, and consumption of thermal energy, and deformation, modification, and the like of the substrate can be reduced, which is preferable.

It is preferable that the alignment step includes a heating treatment. As a result, the liquid crystal component in the coating film can be aligned. Therefore, the heated coating film can be suitably used as the optically-anisotropic layer.

The heating treatment is performed preferably in 10° C. to 250° C. and more preferably 25° C. to 190° C. from the viewpoint of manufacturing suitability and the like. In addition, the heating time is preferably 1 to 300 seconds and more preferably 1 to 60 seconds.

The alignment step may include a cooling treatment that is performed after the heating treatment. In the cooling treatment, the heated coating film is cooled up to about room temperature (20° C. to 25° C.). As a result, the alignment of the liquid crystal component in the coating film can be immobilized. A cooling unit is not particularly limited, and a well-known method can be used.

Through the above-described steps, the optically-anisotropic layer can be obtained.

In this aspect, as the method of aligning the liquid crystal component in the coating film, the drying treatment, the heating treatment, and the like are performed. However, the present invention is not limited to this aspect, and a well-known alignment treatment can be performed.

(Other Steps)

The method of manufacturing the optically-anisotropic layer may further include a step (hereinafter, also referred to as “curing step”) of curing the optically-anisotropic layer after the above-described alignment step.

For example, in a case where the optically-anisotropic layer has a crosslinking group (polymerizable group), the curing step is performed by heating and/or light irradiation (exposure). In particular, it is preferable that the curing step is performed by light irradiation.

As a light source used for curing, various light sources for infrared light, visible light, ultraviolet light, or the like can be used, but a light source for ultraviolet light is preferable. In addition, during curing, the composition may be irradiated with ultraviolet light while being heated, or may be irradiated with ultraviolet light through a filter that allows transmission of light having a specific wavelength.

In a case where the composition is exposed while being heated, the heating temperature during the exposure is preferably 25° C. to 140 although it depends on the temperature of transition of the liquid crystal component in the optically-anisotropic layer into a liquid crystal phase.

In addition, the exposure may be performed at a nitrogen atmosphere. In a case where the curing of the optically-anisotropic layer progresses by radical polymerization, the inhibition of polymerization by oxygen is reduced. Therefore, it is preferable that the exposure is performed in a nitrogen atmosphere.

In the present invention, the thickness of the optically-anisotropic layer is not particularly limited and may be appropriately set depending on the kind of the liquid crystal compound forming the optically-anisotropic layer, the kind of the dichroic colorant, the wavelength of incidence light that is assumed, and the like.

The thickness of the optically-anisotropic layer is preferably 0.1 to 5.0 μm and more preferably 0.3 to 1.5 μm.

As in the optical element 10A shown in FIG. 6, the optical element 10 according to the embodiment of the present invention may have a configuration in which the alignment film 13 is provided on the support 12 and the optically-anisotropic layer 14 is provided on the alignment film 13.

<Support>

As the support, a transparent support is preferable. In particular, a transparent resin film is suitably used. Examples of the resin film include a polyacrylic resin film such as polymethyl methacrylate, a cellulose resin film such as cellulose triacetate, and a cycloolefin polymer film. Examples of the cycloolefin polymer film include trade name “ARTON”, manufactured by JSR Corporation and trade name “ZEONOR”, manufactured by Zeon Corporation).

The support is not limited to a flexible film and may be a non-flexible substrate such as a glass substrate.

<Alignment Film for Forming Optically-anisotropic layer>

Examples of the alignment film for forming the optically-anisotropic layer include a rubbed film formed of an organic compound such as a polymer, an obliquely deposited film formed of an inorganic compound, a film having a microgroove, and a film formed by lamination of LB films formed with the Langmuir-Blodgett technique using an organic compound such as ω-tricosanoic acid, dioctadecylmethylammonium chloride, or methyl stearate.

As the alignment film, a film formed by rubbing a surface of a polymer layer is preferable. The rubbing treatment is performed by rubbing a surface of a polymer layer with paper or fabric in a given direction multiple times. As the kind of the polymer used for the alignment film, for example, polyimide, polyvinyl alcohol, a polymer having a polymerizable group described in JP1997-152509A (JP-H9-152509A), or a vertical alignment film such as JP2005-097377A, JP2005-099228A, and JP2005-128503A can be preferably used. The vertical alignment film described in the present invention refers to an alignment film in which a major axis of a molecule of the polymerizable rod-shaped liquid crystal compound according to the present invention is aligned to be substantially perpendicular to a rubbing direction of the vertical alignment film. The thickness of the alignment film is not necessarily large as long as it can provide the desired alignment function, and is preferably 0.01 to 5 μm and more preferably 0.05 to 2 μm.

In addition, in the optical element according to the embodiment of the present invention, a so-called photo-alignment film obtained by irradiating a photo-alignable material with polarized light or non-polarized light can also be used. That is, the photo-alignment film may be prepared by applying the photo-alignable material to the support. The irradiation of polarized light can be performed in a direction perpendicular or oblique to the photo-alignment film, and the irradiation of non-polarized light can be performed in a direction oblique to the photo-alignment film.

Preferable examples of the photo-alignable material used in the photo-alignment film that can be used in the present invention include: an azo compound described in JP2006-285197A, JP2007-076839A, JP2007-138138A, JP2007-094071A, JP2007-121721A, JP2007-140465A, JP2007-156439A, JP2007-133184A, JP2009-109831A, JP3883848B, and JP4151746B; an aromatic ester compound described in JP2002-229039A; a maleimide- and/or alkenyl-substituted nadiimide compound having a photo-alignable unit described in JP2002-265541A and JP2002-317013A; a photocrosslinking silane derivative described in JP4205195B and JP4205198B, a photocrosslinking polyimide, polyamide, or ester described in JP2003-520878A, JP2004-529220A, and JP4162850B; and a photodimerizable compound, in particular, a cinnamate compound, a chalcone compound, or a coumarin compound described in JP1997-118717A (JP-H9-118717A), JP1998-506420A (JP-H10-506420A), JP2003-505561A, WO2010/150748A, JP2013-177561A, and JP2014-12823A. Among these, an azo compound, a photocrosslinking polyimide, polyamide, ester, a cinnamate compound, or a chalcone compound is more preferable.

In the present invention, the photo-alignment film is preferably used.

The alignment film including the photo-alignable material is applied to the support, is dried, and is exposed to laser to form the alignment pattern.

In the optical element 10 according to the embodiment of the present invention, the optically-anisotropic layer is aligned by the horizontal rotation alignment. In the optical element 10 shown in FIGS. 1 and 2, the liquid crystal compound 20 of the optically-anisotropic layer 14 has the liquid crystal alignment pattern of the horizontal rotation alignment in which the direction of the optical axis 22 (component parallel to the plane of the optical axis) is the same in the y direction and continuously rotates in the x direction, that is, the axis A direction.

This way, a schematic diagram of an exposure device that exposes the alignment film for forming the optically-anisotropic layer 14 having the liquid crystal alignment pattern is shown in FIG. 10.

An exposure device 50 includes: a light source 54 including a semiconductor laser 52; a beam splitter 56 that splits laser light 70 emitted from the semiconductor laser 52 into two beams 72A and 72B; mirrors 58A and 58B that are disposed on optical paths of the splitted two beams 72A and 72B; and λ/4 plates 60A and 60B. The λ/4 plates 60A and 60B have optical axes perpendicular to each other, the λ/4 plate 60A converts the linearly polarized light P₀ into right circularly polarized light P_{R}, and the λ/4 plate 60B converts the linearly polarized light P₀ into left circularly polarized light P_{L}.

A support 80 including the non-exposed alignment film 13 is disposed at an exposed portion, the two beams 72A and 72B intersect and interfere each other on the alignment film 13, and the alignment film 13 is irradiated with and exposed to the interference light. Due to the interference at this time, the polarization state of light with which the alignment film 13 is irradiated periodically changes according to interference fringes. As a result, an alignment pattern in which the alignment state periodically changes can be obtained. In the exposure device 50, by changing an intersection angle β between the two beams 72A and 72B, the pitch of the alignment pattern can be changed. As a result, an alignment pattern corresponding to the liquid crystal alignment pattern conceptually shown in FIG. 2 can be obtained.

As described above, by forming the optically-anisotropic layer 14 on the alignment film 13 having the pattern in which the alignment state periodically changes, the optically-anisotropic layer having the liquid crystal alignment pattern corresponding to the period can be formed.

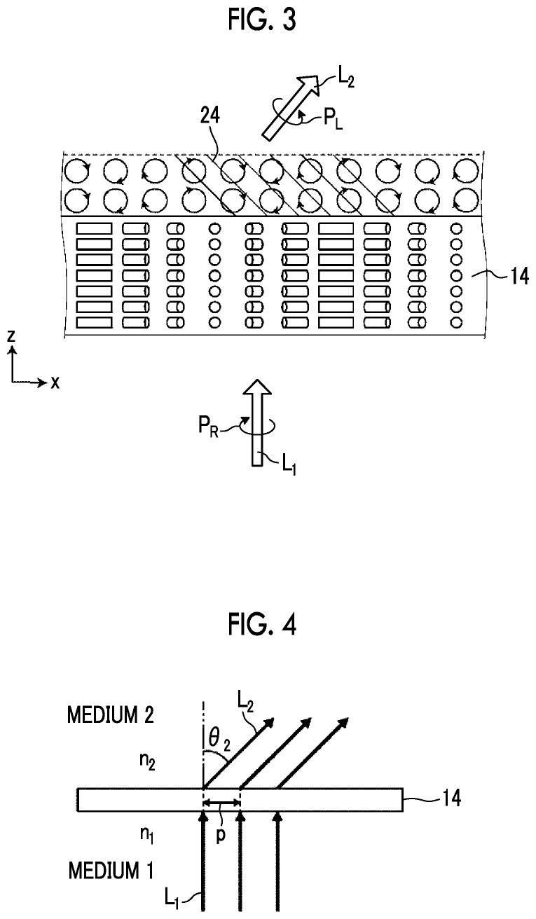

FIG. 3 is a diagram schematically showing the principle in which the incidence light L₁ incident from the normal direction into the optical element 10 is emitted at the predetermined emission angle θ₂. Hereinafter, the action will be described with reference to FIG. 3.

First, a case where right circularly polarized light P_{R} having the wavelength λ is used as the incidence light L₁ will be described.

The incidence light L₁ as the right circularly polarized light P_{R} transmits through the optically-anisotropic layer 14 to be imparted with a phase difference of λ2 and is converted into left circularly polarized light P_{L}. In addition, in the optically-anisotropic layer 14, the absolute phase of the incidence light L₁ changes due to the direction of the optical axis 22 of the liquid crystal compound 20 in each of the regions.

Here, in the optically-anisotropic layer 14, the direction of the optical axis 22 of the liquid crystal compound 20 changes while rotating in the axis A direction (in this example, the x-axis direction). Therefore, the amount of change in absolute phase varies depending on the direction of the optical axis 22 at x coordinates of a plane (x-y plane) of the optically-anisotropic layer 14 into which the incidence light L₁ is incident. In a region indicated by a broken line in FIG. 3, the state where the amount of change in absolute phase varies depending on x coordinates is schematically shown.

As shown in FIG. 3, due to a shift of the absolute phase in a case where the incidence light L₁ passes through the optically-anisotropic layer 14, an equiphase surface 24 having an absolute phase with an angle with respect to the plane of the optically-anisotropic layer 14 is formed. As a result, a refractive power in a direction perpendicular to the equiphase surface 24 is applied to the incidence light L₁ incident from the normal direction such that the traveling direction of the incidence light L₁ changes. That is, the incidence light L₁ as the right circularly polarized light P_{R} is converted into left circularly polarized light P_{L} after passing through the optically-anisotropic layer 14, and is emitted from the optically-anisotropic layer 14 as the emitted light L₂ that travels in a direction having the predetermined angle θ₂ with respect to the normal direction.

As described above, in the optical element 10, the incidence light L₁ incident in the normal direction of the optical element 10 is emitted as the emitted light L₂ in a direction different from the normal direction.

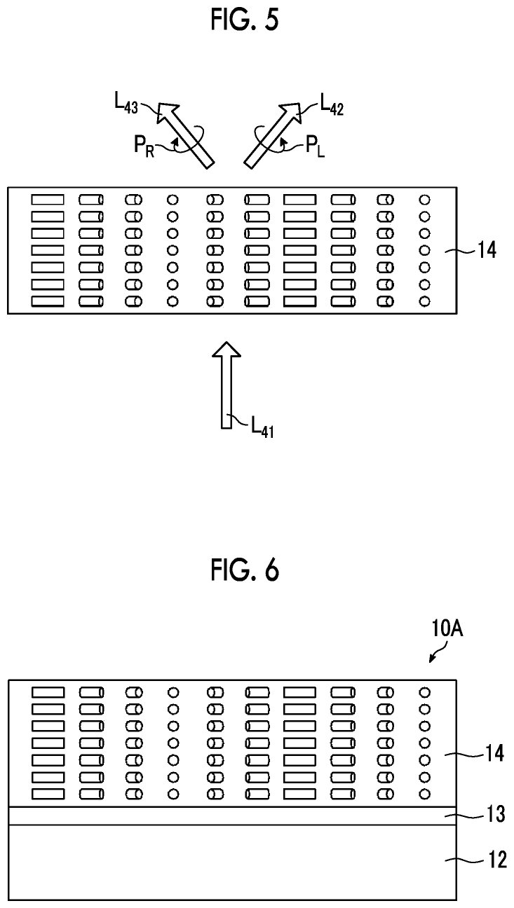

In a case where the incidence light is left circularly polarized light, the behavior of the like is opposite to the incidence light L₁ that is the above-described right circularly polarized light P_{R} (refer to FIG. 5).

By changing the rotation period p of the direction of the optical axis 22 in the liquid crystal alignment pattern of the optically-anisotropic layer 14, the slope of the emission angle L₂ can be changed. As the rotation period p decreases, a high refractive power can be applied to the incidence light L₁, and thus the slope of the emitted light L₂ with respect to the normal direction increases.

In addition, as the wavelength of the incidence light L₁ increases, a high refractive power can be applied to the incidence light L₁.

Accordingly, in the optical element 10 according to the embodiment of the present invention, the rotation period p of the direction of the optical axis 22 in the liquid crystal alignment pattern may be set depending on, for example, the wavelength of light assumed as the incidence light L₁, that is, the wavelength λ, and a desired traveling direction of the emitted light L₂.

This way, due to the liquid crystal alignment pattern in the optically-anisotropic layer 14, the amount of change in absolute phase can be changed to change a wave surface of the incidence light.

In a case where the optical element 10 has the liquid crystal alignment pattern of the rotation period p that is uniform only in one direction, the conversion of the incidence light L₁ into the emitted light L₂ based on the above-described principle can be described as transmission diffraction.

The optically-anisotropic layer 14 functions as a transmission diffraction grating with respect to the incidence light L₁, and the incidence light L₁ vertically incident into the optically-anisotropic layer 14 is transmitted and diffracted as transmitted and diffracted light L₂ having a predetermined diffraction angle θ₂. In this case the following Expression (1) that is an general expression for light diffraction is satisfied.

n₂ sin θ₂−n₁ sin θ₁=mλ/p Expression (1)

Here, n₁ represents a refractive index of a medium 1 on the incidence surface side of a diffraction grating, θ₁ represents an incidence angle, n₂ represents a refractive index of a medium 2 on the emission surface side of a diffraction grating, θ₂ represents a diffraction angle (emission angle), λ represents a wavelength, p represents a rotation period, and m represents a diffraction order. The diffraction grating described here is the optically-anisotropic layer 14.

Here, conditions are set such that the maximum diffraction efficiency is obtained at m=1. In addition, here, since incidence angle θ₁=0°, Expression (1) is as follows.

n₂ sin θ₂=λ/p Expression (2)

FIG. 4 is a diagram schematically showing the diffraction phenomenon represented by Expression (2).

The optically-anisotropic layer 14 as a diffraction grating is disposed between the medium n1 and the medium n₂. The light L₁ incident from the medium 1 side having a refractive index n₁ into the optically-anisotropic layer 14 in the normal direction is diffracted due to the diffraction effect from the optically-anisotropic layer 14 and is emitted to the medium 2 side having a refractive index n₂. At this time, the emitted light L₂ emitted at the emission angle θ₂ can be rephrased with the transmitted and diffracted light L₂ having the diffraction angle θ₂.

This way, the optically-anisotropic layer 14 obtained by performing the horizontal rotation alignment on the liquid crystal compound 20 to be immobilized functions as diffraction grating.

The optical element 10 according to the embodiment of the present invention has a characteristic in that the optically-anisotropic layer 14 includes the dichroic colorant in addition to the liquid crystal compound 20 that is aligned by the horizontal rotation alignment. Examples of this structure include a so-called guest host liquid crystal. In the present invention, the liquid crystal compound 20 is a host, and the dichroic colorant is a guest.

In the optical element according to the embodiment of the present invention, light absorbed by the dichroic colorant in the optically-anisotropic layer 14 has a wavelength different from the wavelength of the light assumed as incidence light in the optical element 10 according to the embodiment of the present invention, that is, the wavelength λ. For example, in a case where the wavelength λ is 940 nm in an infrared range, the dichroic colorant in the optically-anisotropic layer 14 absorbs, for example, light in any wavelength range of visible light.

As a result, in a case where diffracted light having the wavelength λ is used, the diffracted light having the wavelength λ can be efficiently used without being affected by light having a wavelength other than the wavelength λ as an error.

The present inventors found that, in a case where the liquid crystal compound 20 of the optically-anisotropic layer 14 is aligned by the horizontal rotation alignment and the optically-anisotropic layer 14 includes the dichroic colorant, the effect of light having a wavelength other than the wavelength λ as an error during use of the diffracted light having the wavelength λ can be reduced, and the diffracted light of incidence light that is assumed can be efficiently used.

As described above, the horizontal rotation alignment of the liquid crystal compound 20 represents that the liquid crystal alignment pattern in which the optical axis 22 of the rod-shaped liquid crystal compound is parallel to a plane of the optically-anisotropic layer and the optical axis 22 (component parallel to the plane of the optical axis) changes while changing in at least one direction.

On the other hand, the wavelength λ is the wavelength of light that is desired to be diffracted by from the optically-anisotropic layer 14 of the optical element 10, and is preferably a wavelength at which the retardation R (=Δn·d₁) is half of a wavelength in a case where the optically-anisotropic layer 14 is set to achieve the highest diffraction efficiency is the highest in the present invention. That is, the wavelength λ can also be referred to as the wavelength obtained by multiplying Δn·d₁ by 0.5. Δn represents the birefringence of the optically-anisotropic layer 14 (the liquid crystal compound 20), and d₁ represents the thickness of the optically-anisotropic layer 14.

In a case where the liquid crystal compound 20 is aligned by the horizontal rotation alignment and the optically-anisotropic layer 14 includes the dichroic colorant, the reason why the effect of light having the wavelength assumed as incidence light, that is light having a wavelength other than the wavelength λ as an error during use of the diffracted light having the wavelength λ can be reduced and the diffracted light of incidence light that is assumed can be efficiently used is presumed to be as follows.

As shown in FIG. 3, light vertically incident into the optically-anisotropic layer travels obliquely in the optically-anisotropic layer 14 due to the refractive power caused by the liquid crystal compound 20 that is aligned by the horizontal rotation alignment.

Here, the dichroic colorant as the guest is also aligned by the horizontal rotation alignment as in the liquid crystal compound 20 as the host. Accordingly, the dichroic colorant does not interfere with the alignment and optical action of the liquid crystal compound 20.

In a case where the optically-anisotropic layer 14 includes the dichroic colorant, the absorption wavelength of the dichroic colorant is set to be different from the wavelength λ, and thus does not affect the light having the wavelength λ. On the other hand, the light having the absorption wavelength of the dichroic colorant is absorbed. As a result, in a case where the dichroic colorant that absorbs light having a wavelength other than the wavelength λ is included, the effect of light having a wavelength other than the wavelength of light assumed as the incidence light, that is, disturbance noise as an error can be reduced during use of the diffracted light having the wavelength λ, and the diffracted light having the wavelength λ can be efficiently used.

In the optical element 10 according to the embodiment of the present invention, the wavelength λ, that is, the wavelength of light at which the diffraction effect occurs at the highest efficiency is not particularly limited, and may be in a range of ultraviolet light, visible light, infrared light, or an electromagnetic wave.

As described above, at the same rotation period p of the liquid crystal compound 20, as the wavelength of the incidence light increases, the diffraction angle increases, and as the wavelength of the incidence light decreases, the diffraction angle decreases.

As shown in FIGS. 1 and 3, in a case where incidence light L₁ of right circularly polarized light P_{R} is incident along the normal line of the surface of the optical element 10, light L₂ of left circularly polarized light P_{L} is emitted in a direction having the angle θ₂ with respect to the normal direction.

On the other hand, in a case where left circularly polarized light is incident into the optical element 10 as incidence light, the incidence light is converted into right circularly polarized light in the optically-anisotropic layer 14, and the traveling direction is changed by a refractive power in a direction opposite to that of FIG. 1.

Accordingly, as conceptually shown in FIG. 5, in a case where randomly polarized incidence light L₄₁ is incident into the optical element 10, right circularly polarized light P_{R} in the incidence light L₄₁ is converted into left circularly polarized light P_{L} in the optically-anisotropic layer 14 as described above, the traveling direction is changed by a refractive power due to the liquid crystal alignment pattern, and the left circularly polarized light P_{L} transmits through the optically-anisotropic layer to be emitted as first transmitted and diffracted light L₄₂.

On the other hand, left circularly polarized light P_{L} in the incidence light L₄₁ is converted into right circularly polarized light P_{R} in the optically-anisotropic layer 14, the traveling direction is changed by a refractive power in a direction opposite to that of the left circularly polarized light converted from the right circularly polarized light, and the right circularly polarized light P_{R} transmits through the optically-anisotropic layer 14 to be emitted as second transmitted and diffracted light L₄₃ from a surface opposite to the optical element 10. The traveling directions of the first transmitted and diffracted light L₄₂ and the second transmitted and diffracted light L₄₃ are substantially axisymmetric to each other with respect to the normal line.

In the optical element according to the embodiment of the present invention, it is not necessary that the 180° rotation period in the optically-anisotropic layer is uniform over the entire surface. In addition, the optically-anisotropic layer may have a portion where the direction of the optical axis is constant as long as a part thereof has the liquid crystal alignment pattern in which the direction of the optical axis rotates in at least one in-plane direction (axis A)

In the above description, the example in which incidence light is vertically incident into the optically-anisotropic layer. However, even in a case where incidence light is obliquely incident into the normal line, the effect of transmission diffraction can also be obtained. In a case where incidence light is obliquely incident into the optically-anisotropic layer, the rotation period p may be designed in consideration of the incidence angle θ₁ such that Expression (1) is satisfied and the desired diffraction angle θ₂ can be obtained.

As in the optically-anisotropic layer 14 of the optical element 10 shown in FIGS. 1 and 2, in a case where the optically-anisotropic layer has, uniformly in a plane, the liquid crystal alignment pattern in which the optical axis parallel to the plane changes while rotating in the rotation period p that is constant in the in-plane direction, the emission direction is fixed to the one direction.

On the other hand, in the liquid crystal alignment pattern, the direction in which the optical axis changes while rotating is not limited to one direction, and two directions or a plurality of directions may be adopted. By using the optically-anisotropic layer 14 including the liquid crystal alignment pattern corresponding to the desired direction of reflected light, incidence light can be reflected in the desired direction.

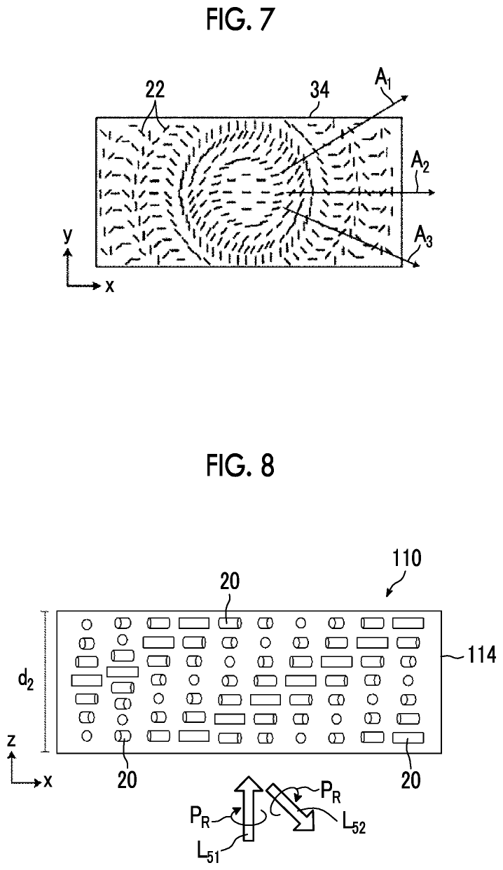

FIG. 7 is a schematic plan view showing an optically-anisotropic layer 34 in a design modification example of the optical element. A liquid crystal alignment pattern in an optically-anisotropic layer 34 is different from the liquid crystal alignment pattern in the optically-anisotropic layer 14 according to the above-described embodiment. FIG. 7 shows only the optical axis 22.

The optically-anisotropic layer 34 in FIG. 7 has the liquid crystal alignment pattern in which the direction of the optical axis 22 gradually changes while rotating in multiple directions from the center side toward the outside, for example along axes A₁, A₂, A₃, and . . . .

That is, the liquid crystal alignment pattern in the optically-anisotropic layer 14A shown in FIG. 10 is a liquid crystal alignment pattern in which the optical axis 22 rotates radially. In other words, the liquid crystal alignment pattern in the optically-anisotropic layer 14A shown in FIG. 10 is a concentric circular pattern having a concentric circular shape where the in-plane direction in which the direction of the optical axis changes while continuously rotating moves from an inside toward an outside.

Depending on the liquid crystal alignment pattern shown in FIG. 7, the absolute phase of incidence light changes by different amounts of change between local regions having different directions of the optical axes 22. In a case where the liquid crystal alignment pattern in which the optical axes radially change while rotating is provided as shown in FIG. 7, incidence light can be caused to transmit through the optically-anisotropic layer as diverging light or converging light. That is, the optical element can implement a function as a convex lens or a concave lens by the liquid crystal alignment pattern in the optically-anisotropic layer 34.

FIG. 8 is a schematic side view showing a configuration of an optical element 110 according to a second embodiment of the present invention. The schematic plan view showing the liquid crystal alignment pattern in the optically-anisotropic layer of the optical element according to the second embodiment is the same as that of the first embodiment shown in FIG. 2.

The optical element 110 according to the second embodiment includes an optically-anisotropic layer 114. As shown in FIG. 6, the optical element 110 according to the embodiment may have the configuration in which the optically-anisotropic layer is formed on the alignment film formed on the support.

In the optical element 110, the alignment of liquid crystal in the optically-anisotropic layer 114 in the thickness direction is different from that of the optically-anisotropic layer 14 according to the first embodiment.

The optically-anisotropic layer 114 is the same as the optically-anisotropic layer 14 in that a liquid crystal compound 20 is aligned by the horizontal rotation alignment in an in-plane direction. On the other hand, the optically-anisotropic layer 114 is different from the optically-anisotropic layer 14 in that the liquid crystal compound 20 is cholesterically aligned in a thickness direction. That is, the optically-anisotropic layer 114 is a cholesteric liquid crystal layer obtained by immobilizing a cholesteric liquid crystalline phase.

The optically-anisotropic layer 114 forming the optical element 110 according to the embodiment of the present invention includes the dichroic colorant in addition to the liquid crystal compound 20.

The optically-anisotropic layer 114 as the cholesteric liquid crystal layer exhibits a function of selectively reflecting only light in a predetermined selective wavelength range in specific circularly polarized light (right circularly polarized light or left circularly polarized light). In the cholesteric liquid crystal layer, a center wavelength (selective reflection center wavelength) of light that is selectively reflected is determined depending on the helical pitch and the thickness d₂ of the cholesteric liquid crystalline phase. In addition, in the cholesteric liquid crystal layer, a rotation direction in which circularly polarized light is selectively reflected is determined depending on the helical turning direction. The helical pitch of the cholesteric liquid crystalline phase is the length in a helical axis direction over which the liquid crystal compound is helically twisted and aligned by 360°.

In the optically-anisotropic layer 114 of the optical element 110 shown in FIG. 8, a change of the optical axis 22 of the liquid crystal compound 20 in an in-plane direction is the same as that in the optically-anisotropic layer 14 of the optical element 10 according to the first embodiment shown in FIG. 2. Therefore, the optically-anisotropic layer 114 exhibits the same effect as that of the above-described optically-anisotropic layer 14. Accordingly, as in the optical element 10 according to the first embodiment, the optically-anisotropic layer 114 of the optical element 110 exhibits an action of obliquely refracting incidence light by changing an absolute phase with respect to the incidence light.

That is, regarding circularly polarized light incident into the optically-anisotropic layer 114 as the cholesteric liquid crystal layer, an absolute phase changes depending on the direction of the optical axis of the liquid crystal compound 20. In FIG. 8, although the optical axis of the liquid crystal compound is not shown, the liquid crystal compound 20 is, for example, a rod-shaped liquid crystal compound, and the optical axis matches the longitudinal direction.

Here, in the optically-anisotropic layer 114, the optical axis of the liquid crystal compound 20 changes while rotating in the direction (x direction) along the axis A. Therefore, the amount of change in the absolute phase of the incident circularly polarized light varies depending on the direction of the optical axis. Further, the liquid crystal alignment pattern of the optically-anisotropic layer 114 is a pattern that is periodic in one direction. Therefore, an absolute phase that is periodic in one direction corresponding to the direction of the optical axis is applied to the circularly polarized light incident into the optically-anisotropic layer 114.

As a result, in a case where circularly polarized light is incident into the optically-anisotropic layer 114, an equiphase surface that is tilted in the direction along the axis A with respect to the main surface (x-y plane) of the optically-anisotropic layer 14 is formed. Therefore, the circularly polarized light incident into the optically-anisotropic layer is reflected in the normal direction of the equiphase surface, and is reflected in a direction that is tilted in the direction along the axis A with respect to the x-y plane.

For example, the optically-anisotropic layer 114 as the cholesteric liquid crystal layer is designed to reflect right circularly polarized light having a predetermined center wavelength. In this case, as shown in FIG. 8, in a case where light L₅₁ having a predetermined center wavelength that is right circularly polarized light is incident along the normal line of the optical element 110, reflected light L₅₂ that travels in a direction having a slope with respect to the normal direction is generated. That is, the optically-anisotropic layer 114 functions as a reflective diffraction grating for the light L₅₁.

Light having a wavelength other than the predetermined selective wavelength range and left circularly polarized light transmits through the optically-anisotropic layer 114.

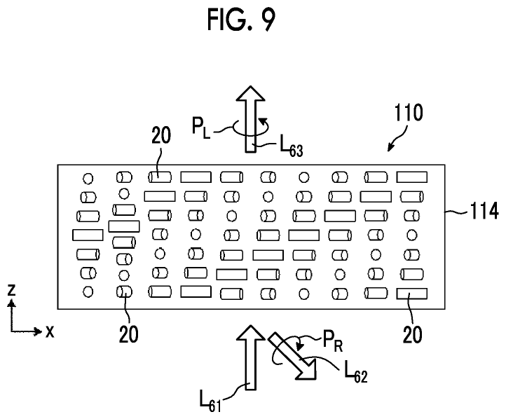

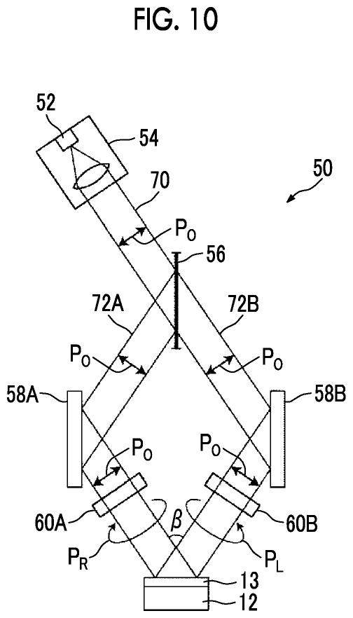

Accordingly, as conceptually shown in FIG. 9, in a case where a randomly polarized light L₆₁ having a predetermined center wavelength is vertically incident into the optically-anisotropic layer 114, only right circularly polarized light L₆₂ is reflected and diffracted, and left circularly polarized light L₆₃ transmits through the optically-anisotropic layer 114.

Here, the optically-anisotropic layer 114 includes the dichroic colorant that absorbs light having a wavelength other than the wavelength of light assumed as incidence light, that is, the wavelength λ.

In the optically-anisotropic layer 114 as a cholesteric liquid crystal layer, the selective reflection center wavelength of the cholesteric liquid crystal layer is the wavelength λ, or the selective reflection wavelength range of the cholesteric liquid crystal layer is the wavelength λ.

As a result, as in the above-descried optical element 10, the light having a wavelength other than the wavelength λ that is selectively reflected from the optically-anisotropic layer 114 is absorbed by the dichroic colorant, the effect of light having a wavelength other than the wavelength λ, that is, disturbance noise as an error can be reduced during use of the reflected light having the wavelength λ, and reflected light of the light having the wavelength λ assumed as reflected light can be efficiently used.

The optical element according to the embodiment of the present invention may include a combination of a plurality of optically-anisotropic layers that are formed of cholesteric liquid crystal layers having different reflection wavelength ranges in which light is selectively reflected.

The optically-anisotropic layer 114 as the cholesteric liquid crystal layer can be formed using a well-known method of forming a cholesteric liquid crystal layer.

For example, the optically-anisotropic layer 14 in the optical element 10 according to the first embodiment and the optically-anisotropic layer 114 in the optical element 110 according to the second embodiment can adopt basically the same forming method, except that the optically-anisotropic layer-forming composition for forming the optically-anisotropic layer 114 as the cholesteric liquid crystal layer includes a chiral agent.

Next, an example of an optical device including the optical element according to the embodiment of the present invention will be described.

The optical element according to the embodiment of the present invention can be used as a light transmission element that allows transmission of light by refracting the light in a direction different from an incidence direction, a light reflection element that reflects light in a direction different from the incidence angle, or an optical path changing device or the like in a sensor, a projector, or the like. Further, the optical element according to the embodiment of the present invention can be applied to a light collecting mirror or a lens for a sensor, a reflective screen that diffuses light, or the like as a micromirror or a microlens that collects or diffuses light.

### EXAMPLES

Hereinafter, the characteristics of the present invention will be described in detail using examples. Materials, chemicals, used amounts, material amounts, ratios, treatment details, treatment procedures, and the like shown in the following examples can be appropriately changed within a range not departing from the scope of the present invention. Accordingly, the scope of the present invention is not limited to the following specific examples.

### Example 1

(Support and Saponification Treatment of Support)

As the support, a commercially available triacetyl cellulose film (manufactured by Fujifilm Corporation, Z-TAC) was prepared.

The support was caused to pass through an induction heating roll at a temperature of 60° C. such that the support surface temperature was increased to 40° C.

Next, an alkali solution shown below was applied to a single surface of the support using a bar coater in an application amount of 14 mL (liter)/m², the support was heated to 110° C., and the support was transported for 10 seconds under a steam infrared electric heater (manufactured by Noritake Co., Ltd.).

Next, 3 mL/m² of pure water was applied to a surface of the support to which the alkali solution was applied using the same bar coater. Next, water cleaning using a foundry coater and water draining using an air knife were repeated three times, and then the support was transported and dried in a drying zone at 70° C. for 10 seconds. As a result, the alkali saponification treatment was performed on the surface of the support.

Alkali Solution

| | | |
|---|---|---|
| Potassium hydroxide | 4.70 | parts by mass |
| Water | 15.80 | parts by mass |
| Isopropanol | 63.70 | parts by mass |
| Surfactant SF-1: C₁₄H₂₉O(CH₂CH₂O)₂OH | 1.0 | part by mass |
| Propylene glycol | 14.8 | parts by mass |

(Formation of Undercoat Layer)

The following undercoat layer-forming coating solution was continuously applied to the surface of the support on which the alkali saponification treatment was performed using a #8 wire bar. The support on which the coating film was formed was dried using warm air at 60° C. for 60 seconds and was dried using warm air at 100° C. for 120 seconds. As a result, an undercoat layer was formed.

Undercoat Layer-Forming Coating Solution

| | |
|---|---|
| The following modified polyvinyl alcohol | 2.40 parts by mass |
| Isopropyl alcohol | 1.60 parts by mass |
| Methanol | 36.00 parts by mass |
| Water | 60.00 parts by mass |

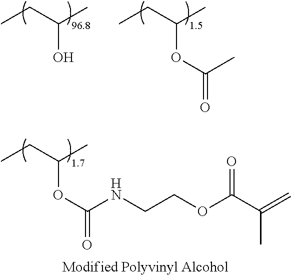

(Formation of Alignment Film)

The following alignment film-forming coating solution was continuously applied to the support on which the undercoat layer was formed using a #2 wire bar. The support on which the coating film of the alignment film-forming coating solution was formed was dried using a hot plate at 60° C. for 60 seconds. As a result, an alignment film was formed.

Alignment Film-Forming Coating Solution

| | | |
|---|---|---|
| The following material A for photo-alignment | 1.00 | part by mass |
| Water | 16.00 | parts by mass |
| Butoxyethanol | 42.00 | parts by mass |
| Propylene glycol monomethyl ether | 42.00 | parts by mass |

Material A for Photo-Alignment

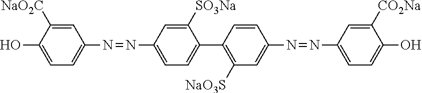

(Exposure of Alignment Film)

The alignment film was exposed using the exposure device shown in FIG. 10 to form an alignment film P-1 having an alignment pattern.

In the exposure device, a laser that emits laser light having a wavelength (325 nm) was used as the laser. The exposure dose of the interference light was 100 mJ/cm². The rotation period of an alignment pattern formed by interference of two laser beams was controlled by changing an intersection angle (intersection angle α) between the two beams. As described above, the rotation period of the alignment pattern is the length in the plane direction over which the optical axis derived from the liquid crystal compound rotates by 180° in one direction.

(Preparation of Optically-Anisotropic Layer-Forming Composition)

As the liquid crystal composition forming the optically-anisotropic layer, the following composition A-1 was prepared. The composition A-1 was heated at 50° to melt for 3 hours while being stirred and was filtered through a 0.45 μm filter.

Composition A-1

| | |
|---|---|
| The following dichromatic colorant compound D1 | 9.3 parts by mass |
| The following dichromatic colorant compound D2 | 2.1 parts by mass |
| The following high-molecular-weight liquid | 72.2 parts by mass |
| crystal compound M1 | |
| Polymerization initiator IRGACURE 819 | 0.8 parts by mass |
| (manufactured by BASF SE) | |
| The following interface improver F-1 | 0.6 parts by mass |
| Cyclopentanone | 640.4 parts by mass |
| Tetrahydrofuran | 74.4 parts by mass |

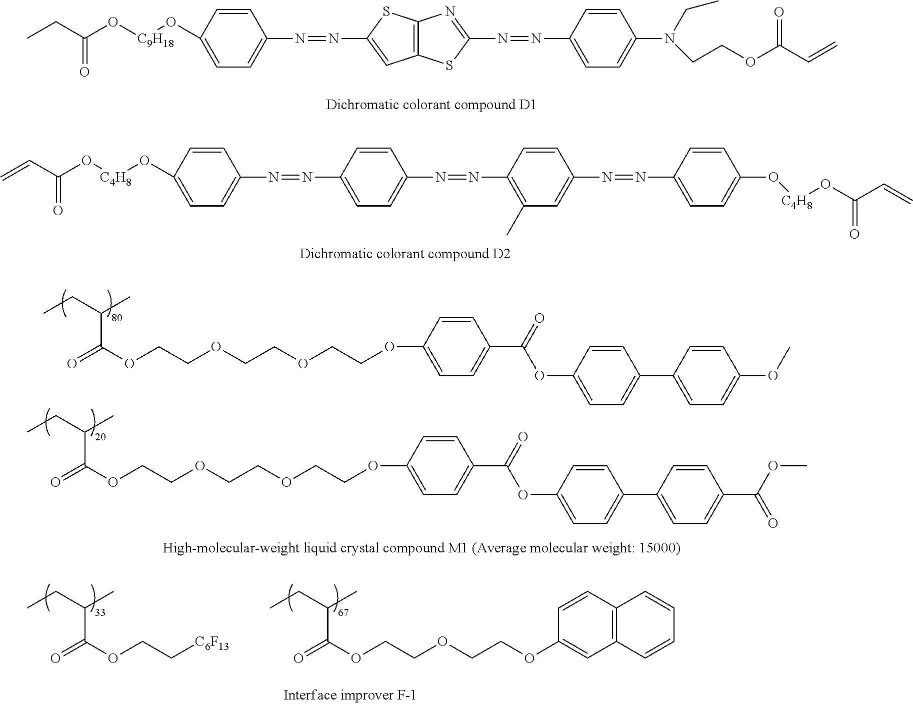

(Formation of Optically-Anisotropic Layer A-1)

The composition A-1 was applied to the photo-alignment film P-1 using a wire bar.

Next, the composition was heated at 140° C. for 90 seconds and was cooled to room temperature (23° C.). Next, the composition was heated at 80° C. for 60 seconds and was cooled to room temperature.

Next, the composition was irradiated with light using a high-pressure mercury lamp under irradiation conditions of an illuminance of 28 mW/cm² for 60 seconds, a first optically-anisotropic layer having a thickness of 0.6 μm as formed.

Regarding the second or subsequent liquid crystal layer, the composition was applied to the first optically-anisotropic layer, and then an optically-anisotropic layer was prepared under the same conditions as described above. This way, by repeating the application three times until the total thickness reached a desired thickness, an achromatic gray optically-anisotropic layer A-1 having a thickness of 2.4 μm was formed as an optical element according to Example 1.

In a case where a spectrum of the optically-anisotropic layer A-1 was measured using a spectrophotometer (manufactured by JASCO Corporation, V-770), the absorption at 940 nm was 31%, and it was found that infrared light was able to be transmitted.

Further, it was verified using a polarizing microscope that the Δn₅₅₀×thickness (Re(550)) of the optically-anisotropic layer A-1 was 470 nm and the optically-anisotropic layer A-1 had the periodic alignment surface, that is, the horizontal rotation alignment as shown in FIG. 2. In the liquid crystal alignment pattern of the optically-anisotropic layer A-1, the rotation period over which the optical axis derived from the liquid crystal compound rotated by 180° was 3.0 μm.

Hereinafter, unless specified otherwise, “Δn₅₅₀×d” and the like were measured as described above.

[Evaluation]

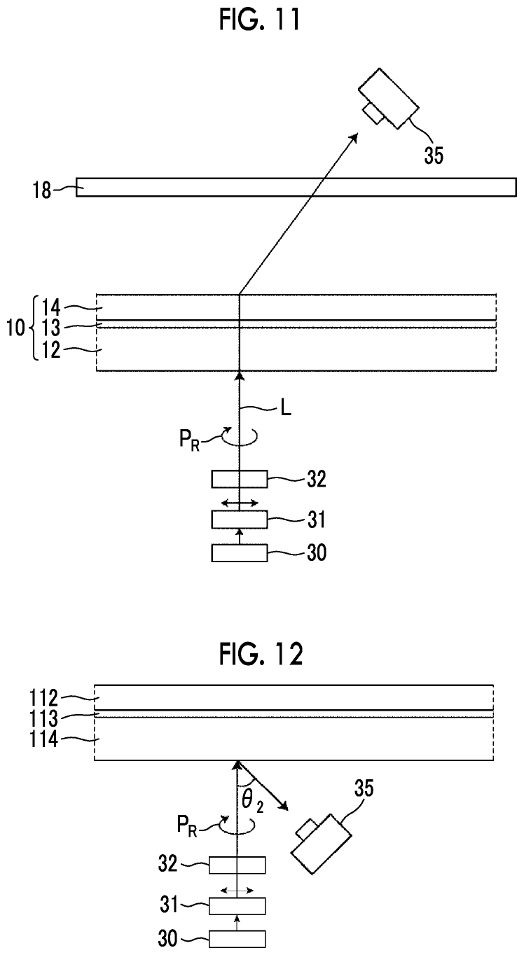

Regarding the optical element according to Example 1, as shown in FIG. 11, light was caused to be vertically incident into the surface of the optically-anisotropic layer 14 through the support 12 of the optical element 10, and the diffraction angle of the transmitted and diffracted light was measured.

Specifically, laser light L having an output center wavelength of 940 nm was emitted from the semiconductor laser 30 and was converted into linearly polarized light by the linear polarizer 31. The linearly polarized light was converted into right circularly polarized light P_{R} by the λ/4 plate 32, and the right circularly polarized light P_{R} was caused to be vertically incident into one surface of the optically-anisotropic layer 14 at a position at a distance of 50 cm in the normal direction.

A spot of the transmitted and diffracted light was captured with a screen 18 disposed at a distance of 50 cm from the another surface of the optical element and was measured by a light-receiving element 35. The transmission diffraction angle was 18°. In addition, based on calculation from the photometry result by the light-receiving element 35, a transmittance of light having a wavelength of 940 nm was 31%.

In addition, the same measurement was performed after emitting laser light having an output center wavelength of 550 nm from the semiconductor laser 30. As a result, a transmittance of light having a wavelength of 550 nm as visible light was 18%, and it was verified that the absorption was high.

### Comparative Example 1

An optical element according to Comparative Example 1 was prepared using the same method as that of Example 1, except that the following optically-anisotropic layer E-1 was formed instead of the optically-anisotropic layer A-1.

(Preparation of Optically-Anisotropic Layer-Forming Composition)

As the composition forming the optically-anisotropic layer, the following liquid crystal composition E-1 was prepared.

### Liquid Crystal Composition E-1

| | |
|---|---|
| The high-molecular-weight liquid crystal | 72.2 parts by mass |
| compound M1 | |
| Polymerization initiator IRGACURE 819 | 0.8 parts by mass |
| (manufactured by BASF SE) | |
| The interface improver F-1 | 0.6 parts by mass |
| Cyclopentanone | 640.4 parts by mass |
| Tetrahydrofuran | 74.4 parts by mass |

<Formation of Optically-Anisotropic Layer E-1>

Regarding the first liquid crystal layer, the liquid crystal composition E-1 was applied to the alignment film P-1 to form a coating film, the coating film was heated using a hot plate at 110° C., the coating film was cooled to 60° C., and the coating film was irradiated with ultraviolet light having a wavelength of 365 nm at an irradiation dose of 100 mJ/cm² using a high-pressure mercury lamp in a nitrogen atmosphere. As a result, the alignment of the liquid crystal compound was immobilized. At this time, the thickness of the immobilized liquid crystal layer (first liquid crystal immobilized layer) was 0.2 μm.

In order to form the second or subsequent liquid crystal immobilized layer, the liquid crystal composition E-1 was applied to the first liquid crystal immobilized layer multiple times and then was heated, cooled, and cured with ultraviolet light under the above-described conditions. This way, by repeating the application until the total thickness reached a desired thickness, an achromatic transparent optically-anisotropic layer E-1 having a thickness of 2.4 μm was formed as an optical element according to Comparative Example 1.

In a spectrum was evaluated using the same method as that of Example 1, the absorption at 940 nm was 33%, and it was found that infrared light was able to be transmitted.

It was verified using a polarizing microscope as in Example 1 that the Δn₅₅₀×thickness (Re(550)) of the optically-anisotropic layer E-1 was 470 nm and the optically-anisotropic layer A-1 had the periodic alignment surface, that is, the horizontal rotation alignment as shown in FIG. 2. In the liquid crystal alignment pattern of the optically-anisotropic layer E-1, the rotation period over which the optical axis derived from the liquid crystal compound rotated by 180° was 3.0 μm.

[Evaluation]

The same evaluation as that of Example 1 was performed on the optical element according to Comparative Example 1.

As a result, the transmission diffraction angle was 18°. In addition, a transmittance of light having a wavelength of 940 nm was 33%.

On the other hand, a transmittance of light having a wavelength of 550 nm as visible light was 92%, the absorption was low, and it was found that light having a wavelength other than a wavelength of 940 nm causing a disturbance noise was not able to be removed.

### Example 2

(Support and Alignment Film)

The support with the photo-alignment film was used as in Example 1.

(Preparation of Optically-Anisotropic Layer-Forming Composition)

As the liquid crystal composition forming the optically-anisotropic layer, the following composition A-2 was prepared. The composition A-2 was heated at 50° to melt for 3 hours while being stirred and was filtered through a 0.45 μm filter.

Composition A-2

| | |
|---|---|
| Rod-shaped liquid crystal compound L-1 | 100.00 parts by mass |
| Dichromatic colorant compound D1 | 4.65 parts by mass |
| Dichromatic colorant compound D2 | 1.05 parts by mass |
| Polymerization initiator (IRGACURE | 3.00 parts by mass |
| (registered trade name) 907, | |
| manufactured by BASF SE) | |
| Photosensitizer (KAYACURE DETX-S, | 1.00 part by mass |
| manufactured by Nippon Kayaku Co., Ltd.) | |
| Chiral agent Ch-1 | 2.81 parts by mass |
| Leveling agent T-1 | 0.08 parts by mass |
| Cyclopentanone | 340.4 parts by mass |
| Tetrahydrofuran | 74.4 parts by mass |

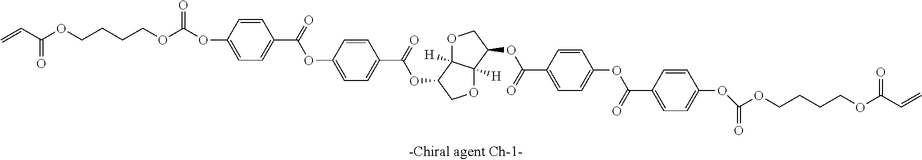 [SMILES: C=CC(=O)OCCCCOC(=O)Oc1ccc(C(=O)Oc2ccc(C(=O)O[C@H]3CO[C@H]4[C@@H]3OC[C@H]4OC(=O)c3ccc(OC(=O)c4ccc(OC(=O)OCCCCOC(=O)C=C)cc4)cc3)cc2)cc1]

(Formation of Optically-Anisotropic Layer A-2)

The composition A-2 was applied to the photo-alignment film P-1 using a wire bar as in Example 1.

Next, the composition was heated at 140° C. for 90 seconds and was cooled to room temperature (23° C.). Next, the composition was heated at 80° C. for 60 seconds and was cooled to room temperature.

Next, the composition was irradiated with light using a high-pressure mercury lamp under irradiation conditions of an illuminance of 28 mW/cm² for 60 seconds, a first optically-anisotropic layer having a thickness of 0.6 μm as formed.

Regarding the second or subsequent liquid crystal layer, the composition was applied to the first optically-anisotropic layer, and then an optically-anisotropic layer was prepared under the same conditions as described above. This way, by repeating the application six times until the total thickness reached a desired thickness, an achromatic gray optically-anisotropic layer A-2 having a thickness of 4.2 μm was formed as an optical element according to Example 3.

It was verified using a polarizing microscope as in Example 1 that the optically-anisotropic layer A-2 had the periodic alignment surface, that is, the horizontal rotation alignment as shown in FIG. 2. In the liquid crystal alignment pattern of the optically-anisotropic layer A-2, the rotation period over which the optical axis derived from the liquid crystal compound rotated by 180° was 1.1 μm.

[Evaluation]

Regarding the optical element according to Example 2, as shown in FIG. 12, light was caused to be vertically incident into the surface of the optically-anisotropic layer, and the diffraction angle of the reflected and diffracted light was measured. In FIG. 12, reference numeral 112 represents the support, and reference numeral 113 represents the alignment film. As described above, the support 12 and the alignment film 13 are the same as those of Example 1.

Specifically, laser light having an output center wavelength of 940 nm was emitted from the semiconductor laser 30 and was converted into linearly polarized light by the linear polarizer 31. The linearly polarized light was converted into right circularly polarized light P_{R} by the λ/4 plate 32, and the right circularly polarized light P_{R} was caused to be vertically incident into one surface of the optically-anisotropic layer 114 at a position at a distance of 50 cm in the normal direction.

The reflected and diffracted light from the optically-anisotropic layer 114 was measured using the light-receiving element 35 disposed at a distance of 50 cm from the optically-anisotropic layer 114.

As a result, the reflection diffraction angle (θ₂) was 18°. In addition, a reflectivity of light having a wavelength of 940 nm was 90%.

In addition, a LED light source light having an output center wavelength of 530 nm was emitted from a specular reflection direction of the light-receiving element 35 for the measurement. As a result, a reflectivity of light having a wavelength of 530 nm as visible light was 5%, and it was verified that the absorption was high.

### Comparative Example 2

An optical element according to Comparative Example 2 was prepared using the same method as that of Example 2, except that the following optically-anisotropic layer E-2 was formed instead of the optically-anisotropic layer A-2.

(Preparation of Optically-Anisotropic Layer-Forming Composition)

As the liquid crystal composition forming the optically-anisotropic layer, the following liquid crystal composition E-2 was prepared. The composition E-2 was heated at 50° to melt for 3 hours while being stirred and was filtered through a 0.45 μm filter.

### Liquid Crystal Composition E-2

| | |
|---|---|
| Rod-shaped liquid crystal compound L-1 | 100.00 parts by mass |
| Polymerization initiator (IRGACURE | 3.00 parts by mass |
| (registered trade name) 907, | |
| manufactured by BASF SE) | |
| Photosensitizer (KAYACURE DETX-S, | 1.00 part by mass |
| manufactured by Nippon Kayaku Co., Ltd.) | |
| Chiral agent Ch-1 | 5.45 parts by mass |
| Leveling agent T-1 | 0.08 parts by mass |
| Methyl ethyl ketone | 268.20 parts by mass |

(Formation of Optically-Anisotropic Layer E-2)

Regarding the first liquid crystal layer, the liquid crystal composition E-2 was applied to the alignment film P-1 to form a coating film, the coating film was heated using a hot plate at 95° C., the coating film was cooled to 25° C., and the coating film was irradiated with ultraviolet light having a wavelength of 365 nm at an irradiation dose of 100 mJ/cm² using a high-pressure mercury lamp in a nitrogen atmosphere. As a result, the alignment of the liquid crystal compound was immobilized. At this time, the thickness of the immobilized liquid crystal layer (first liquid crystal immobilized layer) was 0.2 μm.

In order to form the second or subsequent liquid crystal immobilized layer, the liquid crystal composition E-2 was applied to the first liquid crystal immobilized layer multiple times and then was heated, cooled, and cured with ultraviolet light under the above-described conditions. This way, by repeating the application until the total thickness reached a desired thickness, an achromatic transparent optically-anisotropic layer E-2 having a thickness of 4.2 μm was formed as an optical element according to Comparative Example 2.

It was verified using a polarizing microscope as in Example 1 that the optically-anisotropic layer E-2 had the periodic alignment surface, that is, the horizontal rotation alignment as shown in FIG. 2. In the liquid crystal alignment pattern of the optically-anisotropic layer E-2, the rotation period over which the optical axis derived from the liquid crystal compound rotated by 180° was 1.1 μm.

[Evaluation]

The same evaluation as that of Example 2 was performed on the optical element according to Comparative Example 2.

As a result, the reflection diffraction angle was 18°. In addition, a reflectivity of light having a wavelength of 940 nm was 90%.

On the other hand, a reflectivity of light having a wavelength of 530 nm as visible light was 10%, the absorption was lower than that of Example 2, and it was found that light having a wavelength other than a wavelength of 940 nm causing a disturbance noise caused a noise.

As can be seen from the above results, the effects of the present invention are obvious.

The present invention is suitably applicable to an optical path adjusting member in an optical element such an optical sensor.

### EXPLANATION OF REFERENCES

10, 110: optical element
12, 112: support
13, 113: alignment film
14, 114: optically-anisotropic layer
18: second support
20: liquid crystal compound
22: optical axis
24: equiphase surface
30: semiconductor laser
31: linear polarizer
32: λ/4 plate
35: photodetector
50: exposure device
52: semiconductor laser
54: light source
56: beam splitter
58A, 58B: mirror
60A, 60B: λ/4 plate
70: laser light
72A, 72B: beam

What is claimed is:

1. An optical element comprising:
an optically-anisotropic layer that is formed using a composition including a liquid crystal compound and a dichroic colorant,
wherein the optically-anisotropic layer has a liquid crystal alignment pattern in which a direction of an optical axis derived from the liquid crystal compound changes while continuously rotating in at least one in-plane direction.

2. The optical element according to claim 1,
wherein in the optically-anisotropic layer, directions of optical axes derived from the liquid crystal compound arranged in a thickness direction are the same.

3. The optical element according to claim 1,
wherein the optically-anisotropic layer is a cholesteric liquid crystal layer obtained by immobilizing a cholesteric liquid crystalline phase.
a third lens.

4. The optical element according to claim 1,
wherein the dichroic colorant absorbes light having a wavelength different from a wavelength of light assumed as incidence light.

5. The optical element according to claim 4,
wherein the light assumed as incidence light is infrared light, and the dichroic colorant absorbs light in a wavelength range of visible light.

6. The optical element according to claim 1,
wherein the optically-anisotropic layer includes two or more dichroic colorants.

7. The optical element according to claim 6,
wherein the optically-anisotropic layer includes at least one dichroic colorant having a maximum absorption wavelength in a wavelength range of 370 to 550 nm and at least one dichroic colorant having a maximum absorption wavelength in a wavelength range of 500 to 700 nm.

8. The optical element according to claim 1,
wherein a ratio of a content the dichroic colorant to a content of the liquid crystal compound in the optically-anisotropic layer is 5 mass % to 25 mass %.

9. The optical element according to claim 1,
wherein a retardation of the optically-anisotropic layer in a plane direction with respect to light having a wavelength λ is 0.36λ to 0.64λ.
